(19) United States
(12) Patent Application Publication
(10) Pub. No.: US 2026/0164194 A1
(43) Pub. Date: Jun. 11, 2026

(54) HEARING AID COMPRISING AN INPUT UNIT ASSOCIATED WITH A PLURALITY OF SAMPLING RATES

(71) Applicant: Oticon A/S, Smørum (DK)

(72) Inventors: Michael Syskind PEDERSEN, Smørum (DK); Nels Hede ROHDE, Smørum (DK)

(21) Appl. No.: 19/411,456

(22) Filed: Dec. 8, 2025

(30) Foreign Application Priority Data
Dec. 10, 2024 (EP) 24218710.2

(51) Int. Cl. H04R 25/00; H04S 3/00

(52) U.S. Cl. CPC H04R 25/505; H04S 3/008; H04S 2400/01

(57) ABSTRACT

Disclosed are embodiments of a hearing aid. The hearing aid comprises an input unit configured to provide a first digitized signal associated with a first sampling rate and a second digitized signal associated with a second sampling rate. The first digitized signal comprises a plurality of first frames. The second digitized signal comprises a plurality of second frames. The hearing aid determines the first sampling rate as being different from or as being greater than the second sampling rate such that the time duration of each of each first frame is the same as the time duration of each second frame.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids. The present application relates to a hearing aid comprising an input unit associated with a plurality of sampling rates, and a related method.

### BACKGROUND

A hearing aid is configured to receive a number of analogue signals from a corresponding number of microphones, the number of analogue signals being digitally sampled at a certain sampling rate. An increase in the sampling rate at which an analogue signal is sampled can lead to a more accurate digital representation of such analogue signal. However, a higher sampling rate typically comes with a higher computational cost.

### SUMMARY

There is a need for hearing aids and methods capable of supporting high sampling rates, while ensuring a reduced computational complexity.

### A Hearing Aid:

A hearing aid is disclosed herein. The hearing aid comprises an input unit configured to provide a first digitized signal associated with a first sampling rate and a second digitized signal associated with a second sampling rate. The first digitized signal comprises a plurality of first frames, each of the plurality of first frames comprising a number of first samples. The second digitized signal comprises a plurality of second frames, each of the plurality of second frames comprising a number of second samples. The hearing aid is configured to determine the first sampling rate as being greater than (e.g., or different from) the second sampling rate such that the time duration of each of the plurality of first frames is the same as the time duration of each of the plurality of second frames, thereby causing (e.g., allowing and/or enabling) the number of first samples to be greater than the number of second samples. In other words, the first sampling rate may be different from the second sampling rate such that the time duration of each first frame is the same as the time duration of each second frame. The hearing aid comprises a first analysis filter bank and a second analysis filter bank. The first analysis filter bank is configured to provide a first frequency-domain signal based on the first digitized signal, the first frequency-domain signal being associated with a first frequency range and a second frequency range. For example, the frequency range of the first frequency-domain signal includes the first frequency range and the second frequency range. The second analysis filter bank is configured to provide a second frequency-domain signal based on the second digitized signal, the second frequency-domain signal being associated with the first frequency range. For example, the frequency range of the first frequency-domain signal is (e.g., corresponds) the first frequency range. Determination of the first and second sampling rates (e.g., such that the time duration of each of the plurality of first frames is the same as the time duration of each of the plurality of second frames) causes (e.g., allows and/or enables) the first frequency range of the first frequency-domain signal to comprise the same frequency bands (e.g., frequency components) as the second frequency-domain signal. The hearing aid comprises a signal processing unit configured to determine a first processed signal based on the first frequency range of the first frequency-domain signal and the second frequency-domain signal. The hearing aid comprises an output unit configured to output, based on the first processed signal, an audible signal to the user wearing the hearing aid.

Thereby an improved hearing aid may be provided.

It is an advantage of the present disclosure that, by having the first sampling rate greater than (e.g., different from) the second sampling rate such that the time duration of each of the plurality of first frames (e.g., of a given first frame, such as a first primary frame) is the same as the time duration of each of the plurality of second frames (e.g., of a given second frame, such as a second primary frame), a portion of the first digitized signal (e.g., corresponding to the first frequency range of the first frequency-domain signal) and the second digitized signal can be processed (e.g., combined) by the signal processing unit, despite having the first sampling rate greater than (e.g., different from) the second sampling rate, and due to the fact that the first frequency range of the first frequency-domain signal comprises the same frequency bands as the second frequency-domain signal. In other words, alignment of frame time durations may enable combination of digitized signals associated with different sampling rates. Embodiments of the present disclosure can advantageously allow joint processing of the first digitized signal and the second digitized signal when such digitized signals are associated with different sampling rates.

For example, the first sampling rate is greater than the second sampling rate. Typically, an increase in the sampling rate of an audio signal can lead to a higher computational cost (e.g., requires higher processing capabilities). Embodiments of the present disclosure may, by determining the first processed signal based on the first frequency range of the first frequency-domain signal and the second frequency-domain signal, provide for a satisfactory compromise between computational complexity (e.g., battery performance) and the ability to support high sampling rates.

In one or more example hearing aids, a digitized signal can be construed as a signal sampled at a given sampling rate or sampling frequency (e.g., a digitally sampled signal).

In one or more example hearing aids, the input unit is configured to provide a plurality of digitized signals (e.g., a first digitized signal, a second digitized signal, a third digitized signal, a fourth digitized signal, etc.), each of the plurality of digitized signals being associated with a corresponding sampling rate. Some of such sampling rates may be the same. Such sampling rates may be different from each other.

For example, the input unit can be further configured to provide the third digitized signal associated with a third sampling rate. The third sampling rate may be the same as the second sampling rate and different from the first sampling rate (e.g., when the first sampling rate is greater than the second sampling rate). The third sampling rate may be the same as the first sampling rate and different from the second sampling rate (e.g., when the second sampling rate is greater than the first sampling rate). For example, the input unit can be further configured to provide the fourth digitized signal associated with a fourth sampling rate. The fourth sampling rate may be the same as the second sampling rate and different from the first sampling rate (e.g., when the first sampling rate is greater than the second sampling rate). The fourth sampling rate may be the same as the first sampling rate and different from the second sampling rate (e.g., when the second sampling rate is greater than the first sampling rate). The first sampling rate may be greater than the second sampling rate. The second sampling rate may be greater that the first sampling rate.

In one or more example hearing aids, each of the plurality of digitized signals comprises a plurality of frames (e.g., a first frame, a second frame, a third frame, a fourth frame, etc.). For example, the first digitized signal comprises a plurality of first frames including a first primary frame, a first secondary frame, a first tertiary frame, a first quaternary frame, etc. For example, the second digitized signal comprises a plurality of second frames including a second primary frame, a second secondary frame, a second tertiary frame, a second quaternary frame, etc. For example, the third digitized signal comprises a plurality of third frames including a third primary frame, a third secondary frame, a third tertiary frame, a third quaternary frame, etc. For example, the fourth digitized signal comprises a plurality of fourth frames including a fourth primary frame, a fourth secondary frame, a fourth tertiary frame, a fourth quaternary frame, etc. For example, the first sampling rate is different from the second sampling rate such that the time duration of each of the plurality of first frames is the same as the time duration of each of the plurality of second frames.

In one or more example hearing aids, the first sampling rate is different from the second sampling rate in such a way that each first frame and each corresponding second frame are time aligned. For example, the plurality of first frames is time aligned with the corresponding plurality of second frames, plurality of third frames, plurality of fourth frames, etc. In other words, the plurality of first frames, the plurality of second frames, the plurality of third frames, the plurality of fourth frames, etc. may be time aligned with each other. For example, the first primary frame, the first secondary frame, the first tertiary frame, the first quaternary frame, etc. are timely aligned with the second primary frame, the second secondary frame, the second tertiary frame, the second quaternary frame, etc., respectively. For example, the first primary frame, the first secondary frame, the first tertiary frame, the first quaternary frame, etc. are timely aligned with the third primary frame, the third secondary frame, the third tertiary frame, the third quaternary frame, etc., respectively. For example, the first primary frame, the first secondary frame, the first tertiary frame, the first quaternary frame, etc. are timely aligned with the fourth primary frame, the fourth secondary frame, the fourth tertiary frame, the fourth quaternary frame, etc., respectively. For example, the second primary frame, the second secondary frame, the second tertiary frame, the second quaternary frame, etc. are timely aligned with the third primary frame, the third secondary frame, the third tertiary frame, the third quaternary frame, etc., respectively. For example, the second primary frame, the second secondary frame, the second tertiary frame, the second quaternary frame, etc. are timely aligned with the fourth primary frame, the fourth secondary frame, the fourth tertiary frame, the fourth quaternary frame, etc., respectively.

For example, the first digitized signal and the second digitized signal may be seen as signals sampled at different sampling rates but during the same time duration. For example, the third digitized signal and the fourth digitized signal can be seen as signals sampled using either the first sampling rate (e.g., when the second sampling rate is greater than the first sampling rate) or the second sampling rate (e.g., when the first sampling rate is greater than the second sampling rate).

For example, the first primary frame, the second primary frame, the third primary frame, the fourth primary frame are time aligned with each other. In other words, the first primary frame, the second primary frame, the third primary frame, the fourth primary frame are associated with the same time instances, e.g., with a set of first time instances. For example, the first secondary frame, the second secondary frame, the third secondary frame, the fourth secondary frame are time aligned with each other. In other words, the first secondary frame, the second secondary frame, the third secondary frame, the fourth secondary frame are associated with the same time instances e.g., with a set of second time instances. For example, the first tertiary frame, the second tertiary frame, the third tertiary frame, the fourth tertiary frame are time aligned with each other. In other words, the first tertiary frame, the second tertiary frame, the third tertiary frame, the fourth tertiary frame are associated with the same time instances, e.g., with a set of third time instances. For example, the first quaternary frame, the second quaternary frame, the third quaternary frame, the fourth quaternary frame are time aligned with each other. In other words, the first quaternary frame, the second quaternary frame, the third quaternary frame, the fourth quaternary frame are associated with the same time instances, e.g., with a set of fourth time instances. The set of first time instances, the set of second time instances, the set of third time instances, the set of fourth time instances may be different from each other. The time duration associated with the set of first time instances, the set of second time instances, the set of third time instances, the set of fourth time instances may be the same.

It is an advantage of the present disclosure that, by having the first primary frame and the second primary frame time aligned, a portion of the first digitized signal (e.g., corresponding to the first primary frame) and a portion of the second digitized signal (e.g., corresponding to the second primary frame) can be processed (e.g., combined) by the signal processing unit, despite having the first sampling rate different from the second sampling rate. In other words, alignment of frame time durations may enable combination of digitized signals associated with different sampling rates. For example, when a time frame of a plurality of digitized signals is converted into the frequency domain, it is possible to obtain a set of frequency bands for each of the plurality of digitized signals, the set of frequency bands of each of the plurality of digitized signals having similar frequency content (e.g., similar frequency bands and/or frequency components given in Hz), in turn allowing linear combination of the set of frequency bands of each of the plurality of digitized signals, e.g. in order to obtain spatial filtering.

For example, when a first frame of the plurality of first frames and a corresponding second frame of the plurality of second frames (e.g., frames having the same index) have the same time duration (e.g., the time duration of such first and corresponding second frame comprise the starting time and end time points) and when such first and second frames are converted to the frequency domain, the resulting frequency domain versions of the first and second frames contain the same frequency bands (e.g., the same frequency range), thereby allowing combination of such frequency bands of the resulting frequency domain versions of the first and second digitized signals. For example, only frequencies bands up to half the sampling rate can be reconstructed. For example, the frequency content (e.g., the frequency bands) up to 10 kHz will be the same for the resulting frequency domain versions of the first and second digitized signals when the time duration is an integer multiple of 0.1 milliseconds in view of having first sampling rate being 30 kHz and the second sampling rate being 20 kHz.

For example, by having the plurality of first frames, the plurality of second frames, the plurality of third frames, the plurality of fourth frames, etc. time aligned with each other, the first digitized signal, the second digitized signal, the third digitized signal, the fourth digitized signal, etc. can be combined with each other in the signal processing unit, despite being associated with different sampling rates.

In one or more example hearing aids, the first primary frame is associated with a higher frequency resolution (e.g., comprises more samples) when compared to the second primary frame when the first sampling rate is greater than the second sampling rate. In one or more example hearing aids, the second primary frame is associated with a higher frequency resolution (e.g., comprises more samples) when compared to the first primary frame when the second sampling rate is greater than the first sampling rate.

In one or more example hearing aids, the time duration of a frame can be given by T=N/fₛ, where N denotes the number of samples of the frame and fₛ denotes the sampling rate. For example, the time duration of a frame (e.g., frame duration) may be seen as the length of the frame. For example, the length of the frame can be an integer multiple of the time duration between two samples of such frame which is given by

$$1 / {f}_{s} ( e . g . , \frac{1}{{f}_{s}} N ) .$$

For example, the time duration of each of the plurality of first frames (e.g., of the l-th frame) is given by Tₗ_{₁}=Nₗ_{₁}/fₛ_{₁}, where Nₗ_{₁} denotes the number of samples of the l-th frame of the plurality of first frames and fₛ_{₁} denotes the first sampling rate. For example, the time duration of each of the plurality of second frames (e.g., of the l-th frame) is given by Tₗ_{₂}=Nₗ_{₂}/fₛ_{₂}, where Nₗ_{₁} denotes the number of samples of the l-th frame of the plurality of second frames and fₛ_{₂} denotes the second sampling rate. For example, by the hearing aid (e.g., the input unit) can determine (e.g., select among a set of sampling rates stored in a memory of the hearing aid) the first sampling rate and the second sampling rate by solving (e.g., according to) the following equation:

$${T}_{{l}_{1}} = {T}_{{l}_{2}} \frac{1}{{f}_{{s}_{1}}} {N}_{{l}_{1}} = \frac{1}{{f}_{{s}_{2}}} {N}_{{l}_{2}} , \qquad ( 1 )$$

where Nₗ_{₁} and Nₗ_{₂} positive integers (e.g., Nₗ_{₁}=1, 2, . . . ; Nₗ_{₂}=1, 2, . . . ). In other words, the first sampling rate may be different from the second sampling rate such that Tₗ_{₁}=Tₗ_{₂}.

Embodiments of the present disclosure propose determination of a first processed signal based on input signals digitized using different sampling rates. For example, such a combination is allowed when the time duration (e.g., length) of each frame of each of the digitized signals is the same. The sampling rates of each digitized signals (which are different from one another) may be determined (e.g., selected) according to Equation (1) for allowing such a combination. The sampling rates of each digitized signals (which are different from one another) may be determined (e.g., selected) by fixing the time duration of each frame of each of the digitized signals to the same value for allowing such a combination. For example, each frame of a digitized signal of the digitized signals comprises a different number of samples per frame when compared with other digitized signal of the digitized signals when the digitized signals are associated with different sampling rates and when the time duration of each frame of each of the digitized signals is fixed to the same value. For example, digitized signal (of the digitized signals) associated with a greater sampling rate comprises a greater number of samples per frame than another digitized signal (of the digitized signals) associated with a lower sampling rate when the time duration of each frame of each of the digitized signals is the same.

In one or more example hearing aids, the first sampling rate can be given by 30 kHz and the second sampling rate is given by 20 kHz. The time duration of each of the plurality of first frames and the plurality of second frames may be of 0.1 milliseconds, with each of the plurality of first frames comprising 3 samples and each of the plurality of second frames comprising 2 samples. In one or more example hearing aids, the time duration of each of the plurality of first frames and the plurality of second frames can be given by any integer multiple of 0.1 milliseconds. In other words, the minimum time duration of each of the plurality of first frames and the plurality of second frames may be of 0.1 milliseconds.

In one or more example hearing aids, the first sampling rate can be given by 32 kHz and the second sampling rate is given by 20 kHz. The time duration of each of the plurality of first frames and the plurality of second frames may be of 0.25 milliseconds, with each of the plurality of first frames comprising 8 samples and each of the plurality of second frames comprising 5 samples. In one or more example hearing aids, the time duration of each of the plurality of first frames and the plurality of second frames can be given by any integer multiple of 0.25 milliseconds. In other words, the minimum time duration of each of the plurality of first frames and the plurality of second frames may be of 0.25 milliseconds.

In one or more example hearing aids, the first sampling rate can be given by 44.1 kHz and the second sampling rate is given by 32 kHz. The time duration of each of the plurality of first frames and the plurality of second frames may be of 10 milliseconds, with each of the plurality of first frames comprising 441 samples and each of the plurality of second frames comprising 320 samples. In one or more example hearing aids, the time duration of each of the plurality of first frames and the plurality of second frames can be given by any integer multiple of 10 milliseconds. In other words, the minimum time duration of each of the plurality of first frames and the plurality of second frames may be of 10 milliseconds.

In one or more example hearing aids, the time duration of a frame is an integer multiple of the reciprocal of the greatest common divisor between the first sampling rate and the second sampling rate. The first sampling rate may be a non-integer value. The first sampling rate may be an integer value. The second sampling rate may be a non-integer value. The second sampling rate may be an integer value.

In one or more example hearing aids, the first sampling rate and the second sampling rate are predetermined values. In one or more example hearing aids, the first sampling rate and the second sampling rate can be determined by the hearing aid and/or by an external device. For example, the first sampling rate and the second sampling rate can be determined by retrieving such values from a memory of the hearing aid and/or from the external device.

In one or more example hearing aids, the output unit is configured to provide a stimulus perceived by the user as an acoustic signal based on the first processed signal. The output unit may comprise an output transducer. The output transducer may comprise a receiver (e.g., a loudspeaker) for providing the stimulus as an acoustic signal to the user (e.g., in an acoustic (air conduction based) hearing aid).

The output unit may (additionally or alternatively) comprise a (e.g., wireless) transmitter for transmitting sound picked up-by the hearing aid to another device, e.g. a far-end communication partner (e.g., via a network, e.g., in a telephone mode of operation). In one or more example hearing aids, the wireless transmitter is configured to transmit an electromagnetic signal in the radio frequency range (e.g., 3 kHz to 300 GHz). The wireless transmitter may be configured to transmit an electromagnetic signal in a frequency range of light (e.g., infrared light 300 GHz to 430 THz, or visible light, e.g., 430 THz to 770 THz).

In one or more example hearing aids, the hearing aid comprises a first analysis filter bank and a second analysis filter bank. For example, the input unit is in communication with the first analysis filter bank and the second analysis filter bank. In one or more example hearing aids, the first analysis filter bank is configured to provide a first frequency-domain signal based on the first digitized signal. For example, the first analysis filter bank is configured to provide a time-frequency (TF) representation of the first digitized signal. In other words, the first frequency-domain signal may be indicative of a TF representation of the first digitized signal. In one or more example hearing aids, the first frequency domain signal is associated with a first frequency range and a second frequency range.

In one or more example hearing aids, the second analysis filter bank is configured to provide a second frequency-domain signal based on the second digitized signal. For example, the second analysis filter bank is configured to provide a TF representation of the second digitized signal. In other words, the second frequency-domain signal may be indicative of a time-frequency (TF) representation of the second digitized signal. In one or more example hearing aids, the second frequency-domain signal is associated with the first frequency range. For example, the frequency range of the second frequency-domain signal is a subset of the frequency range of the first frequency-domain signal. In other words, the first sampling rate is greater than the second sampling rate.

In one or more example hearing aids, the hearing aids can comprise a plurality of analysis filter bank including the first analysis filter bank, the second analysis filter bank, a third analysis filter bank, a fourth analysis filter bank, etc. For example, the third analysis filter bank is configured to provide a third frequency-domain signal based on the third digitized signal. For example, the fourth analysis filter bank is configured to provide a fourth frequency-domain signal based on the fourth digitized signal. The third frequency-domain signal may be indicative of a TF representation of the third digitized signal. The fourth frequency-domain signal may be indicative of a TF representation of the fourth digitized signal.

In one or more example hearing aids, a TF representation of a signal (e.g., a digitized signal) may comprise an array or map of corresponding complex or real values of the signal in a given time and frequency range. An analysis filter bank may be configured to filter the signal (e.g., a time varying signal) and providing a number of output signals (e.g., time varying output signals), each of the output signals comprising a distinct frequency range of the signal. In other words, the analysis filter bank may be configured to provide a frequency domain representation of a signal (e.g., of a digitized signal).

For example, an analysis filter bank is configured to apply to the signal (e.g., a digitized signal) one or more of a Discrete Fourier Transform (DFT) algorithm, a Short Time Fourier Transform (STFT) algorithm, a Fast Fourier Transform (FFT) algorithm and any other suitable algorithm. In other words, an analysis filter bank may be configured to convert a time variant signal to a (time variant) signal in the (time-)frequency domain.

For example, the frequency range ranging from a minimum frequency fₘᵢₙ to a maximum frequency fₘₐₓ may comprise a part of the typical human audible frequency range from 20 Hz to 20 kHz (e.g., a part of the range from 20 Hz to 12 kHz). For example, a sampling rate fₛ (e.g., the first sampling rate and/or the second sampling rate) is larger than or equal to twice the maximum frequency fₘₐₓ, fₛ≥2fₘₐₓ. Each of the plurality of digitized signals may be split into a number NI of frequency bands (e.g., of uniform width), where NI is e.g., larger than 5, such as larger than 10, such as larger than 50, such as larger than 100, such as larger than 500, at least some of which are processed individually. The hearing aid may be configured to process each of the plurality of digitized signals in a number NP of different frequency channels (NP≤NI). The frequency channels may be uniform or non-uniform in width (e.g., increasing in width with frequency), overlapping or non-overlapping.

In one or more example hearing aids, the plurality of analysis filter bank (e.g., the first analysis filter bank, the second analysis filter bank, the third analysis filter bank, the fourth analysis filter bank, etc.) is configured to provide a corresponding plurality of frequency-domain signals (e.g., the first frequency-domain signal, the second frequency-domain signal, the third frequency-domain signal, the fourth frequency-domain signal, etc.) by splitting the corresponding plurality of digitized signals (e.g., the first digitized signal, the second digitized signal, the third digitized signal, the fourth digitized signal, etc.) into a set of frequency bands (e.g., a set of first frequency bands, a set of second frequency bands, a set of third frequency bands, a set of fourth frequency bands, etc.).

In one or more example hearing aids, the first analysis filter bank comprises a first frequency resolution. In other words, the first frequency-domain signal is associated with a set of first frequency components. For example, a first part of such set of first frequency components can be construed as the first frequency range of the first frequency-domain signal. Put differently, the first frequency range of the first frequency-domain signal may comprise the first part of such set of first frequency components. For example, a second part of such set of first frequency components can be construed as the second frequency range of the first digitized signal. Put differently, the second frequency range of the first frequency-domain signal may comprise the second part of such set of first frequency components. The frequency range of the first frequency-domain signal may comprise the first part of the set of first frequency components and the second part of the set of first frequency components.

In one or more example hearing aids, the second analysis filter bank comprises a second frequency resolution. In other words, the second frequency-domain signal is associated with a set of second frequency components. For example, such set of second frequency components can be construed as the first frequency range of the second digitized signal. Put differently, the first frequency range of the second digitized signal may comprise the set of second frequency components. The first frequency range of the second digitized signal is the same as the first frequency range of the first digitized signal. In other words, the set of second frequency components may be the same as the first part of the set of first frequency components. The frequency range of the second frequency-domain signal may be seen as the set of second frequency components. For example, the set of second frequency components is the same as the first part of the set of first frequency components in the sense that the frequency components are the same.

In one or more example hearing aids, the third analysis filter bank comprises a third frequency resolution. In other words, the third frequency-domain signal is associated with a set of third frequency components. For example, such set of third frequency components can be construed as the first frequency range of the third digitized signal. Put differently, the first frequency range of the third digitized signal may comprise the set of third frequency components. The first frequency range of the third digitized signal is the same as the first frequency range of the first digitized signal (e.g., and of the second digitized signal). In other words, the set of third frequency components may be the same as the first part of the set of first frequency components (e.g., and of the set of second frequency components). The frequency range of the third frequency-domain signal may be seen as the set of third frequency components.

In one or more example hearing aids, the fourth analysis filter bank comprises a fourth frequency resolution. In other words, the fourth frequency-domain signal is associated with a set of fourth frequency components. For example, such set of fourth frequency components can be construed as the first frequency range of the fourth digitized signal. Put differently, the first frequency range of the fourth digitized signal may comprise the set of fourth frequency components. The first frequency range of the fourth digitized signal is the same as the first frequency range of the first digitized signal (e.g., of the second digitized signal, and of the third digitized signal). In other words, the set of fourth frequency components may be the same as the first part of the set of first frequency components (e.g., of the set of second frequency components, and of the set of third frequency components). The frequency range of the fourth frequency-domain signal may be seen as the set of fourth frequency components.

For example, the frequency resolution of the first analysis filter bank (e.g., the first frequency resolution) is the same as the frequency resolution of the second analysis filter bank (e.g., the second frequency resolution), the frequency resolution of the third analysis filter bank (e.g., the third frequency resolution) and the frequency resolution of the fourth analysis filter bank (e.g., the fourth frequency resolution). On the other hand, the number of frequency bands of the first analysis filter bank is greater than the number of frequency bands of the second analysis filter bank, the third analysis filter bank, and the fourth analysis filter bank. In other words, the first analysis filter bank may cover a frequency range, such as comprising the first frequency range and the second frequency range, greater than the frequency range of the second analysis filter bank, the third analysis filter bank, and the fourth analysis filter bank, such as a frequency range comprising solely the first frequency range. For example, the first analysis filter bank and the second analysis filter bank cover different frequency ranges, the different frequency ranges being related to different sampling rates. The frequency resolution of each analysis filter bank may be determined such that the frequency bands up to the lowest of (e.g., half of) the first and the second sampling rates of each analysis filter bank coincide with each other.

For example, a first analysis filter bank corresponding to a first sampling rate of 30 kHz (e.g., receiving a signal sampled at 30 kHz) comprises 96 frequency bands up to the half of the first sampling rate (e.g., up to 15 kHz), e.g., when applying a 192 point FFT to a digitized signal. For example, the first analysis filter bank can comprise 97 frequency bands, with the first frequency band (e.g., belonging to the first frequency range) and the last frequency band (e.g., belonging to the second frequency range) of the first analysis filter bank being real valued with half-bandwidth. For example, a second analysis filter bank (e.g., and/or a third analysis filter bank and/or fourth analysis filter bank) corresponding to a second sampling rate of 20 kHz (e.g., receiving a signal sampled at 20 kHz) comprises 64 frequency bands up to the half of the second sampling rate (e.g., up to 10 kHz), e.g., when applying a 128 point FFT to a digitized signal. For example, the second analysis filter bank can comprise 65 frequency bands, with the first frequency band (e.g., belonging to the first frequency range) of the second analysis filter bank being real valued with half-bandwidth. The first analysis filter bank and the second analysis filter bank may have the first 64 frequency bands in common.

For example, the first digitized signal x₁[n] when sampled with fₛ_{₁}=30 kHz having a time duration of any integer multiple of 0.1 milliseconds comprises N₁=3 first frames, with n denoting the sample index. For example, the second digitized signal x₂[n] when sampled with fₛ_{₂}=20 kHz having the same time duration as the first digitized signal x₁[n] comprises N₂=2 second frames. The first frequency domain signal resulting from application of an FFT to the first digitized signal can be given by

$$X [ k ] = {\sum }_{n}^{{N}_{1} - 1} {x}_{1} [ n ] \cdot {e}^{- \frac{j 2 π kn}{{N}_{1}}} ,$$

with k denoting the frequency band index. The second frequency domain signal resulting from application of an FFT to the second digitized signal can be given by

$$X [ k ] = {\sum }_{n}^{{N}_{2} - 1} {x}_{2} [ n ] \cdot {e}^{- \frac{j 2 π kn}{{N}_{2}}} .$$

For example, each index k corresponds to a frequency band given by kfₛ/N, in which fₛ=fₛ_{₁} and N=N₁ for the first digitized signal; and fₛ=fₛ_{₂} and N=N₂ for the second digitized signal. As explained above, the first 64 frequency bands of each of the first analysis filter bank and the second analysis filter bank may be combinable as the first 64 frequency bands of each of the first and second analysis filter banks are related to the same time intervals and time durations in virtue of the determination of the first and second sampling rates such that the time duration of each of N₁ first frames is the same as the time duration of each of N₂ second frames. In other words, the first 64 frequency bands of the 192 point FFT may be identical to the first 64 frequency bands of the 128 point FFT, as the time duration of each of the plurality of first and second frames are identical. For example, the 65-th frequency band of the 128 point FFT cannot be combined the 65-th frequency band of the 128 point FFT as the 65-th frequency band is real and the 65-th band for the 192 point FFT is complex-valued.

For example, a linear combination of a number of digitized signals is enabled for the frequency range where both the first analysis filter bank and the second analysis filter bank (e.g., and/or a third analysis filter bank and/or fourth analysis filter bank) have frequency bands and/or frequency channels and/or frequency components in common. The first analysis filter bank and the second analysis filter bank may have the same frequency resolution, with each of the first analysis filter bank and the second analysis filter bank comprising a different number of frequency bands and/or frequency channels. For example, frequency bands, frequency components and frequency channels may be used interchangeably.

In one or more example hearing aids, the signal processing unit is configured to determine a first primary frequency-domain signal based on the first frequency-domain signal. In one or more example hearing aids, the first primary frequency-domain signal is associated with the first frequency range. For example, the first primary frequency-domain signal is associated with the first part of the set of first frequency components. Put differently, the first frequency range of the first frequency-domain signal may comprise the first part of the set of first frequency components. The first frequency range (e.g., of the first primary frequency-domain signal and of the second frequency-domain signal) may be seen as a set of common frequency (CF) components. The set of CF components may be construed as a set of frequency components that are common to both the first frequency-domain signal and the second frequency-domain signal. A set of non-common frequency (NCF) components may be construed as a set of frequency components that are not common to both the first frequency-domain signal and the second frequency-domain signal, e.g., a set of frequency components present in one of the first frequency-domain signal and the second frequency-domain signal.

In one or more example hearing aids, the signal processing unit comprises a first signal processing unit configured to determine a first processed signal based on the first primary frequency-domain signal and the second frequency-domain signal. In one or more example hearing aids, the first signal processing unit is configured to combine the first primary frequency-domain signal with the second frequency-domain signal. Put differently, the first signal processing unit may be configured to combine part of the first frequency-domain signal with the second frequency-domain signal. For example, the first signal processing unit is configured to combine a portion of the first digitized signal (e.g., with such portion being associated with the first frequency range) with the second digitized signal (e.g., the second digitized signal being associated with the same first frequency range). For example, the first signal processing unit is configured to combine portions of the first digitized signal with the second digitized signal, with such portion being associated with the same frequency range as the second digitized signal (e.g., with such portion and the second digitized signal comprising the same set of frequency components). In one or more example hearing aids, the first signal processing unit is configured to combine CF components of the first frequency-domain signal with all frequency components of the second frequency-domain signal. The CF components of the first frequency-domain signal may be construed as frequency components which are all present in the second frequency-domain signal.

In one or more example hearing aids, the first signal processing unit can be configured to combine the first primary frequency-domain signal, the second frequency-domain signal, the third frequency-domain signal, and the fourth frequency-domain signal. For example, the first signal processing unit is configured to combine portions of the first digitized signal, with the second digitized signal, the third digitized signal, and the fourth digitized signal, with such portion being associated with the same frequency range as the second digitized signal, the third digitized signal and the fourth digitized signal. The first signal processing unit may be configured to determine the first processed signal based on the first primary frequency domain signal, the second frequency domain signal, the third frequency domain signal, and the fourth frequency domain signal.

For example, the first signal processing unit is configured to combine the lowest 64 frequency bands of the 96 frequency bands of the first frequency-domain signal and on the 64 frequency bands of the second frequency-domain signal (e.g., and/or the third frequency-domain signal, and/or the fourth frequency-domain signal), when the first sampling rate is of 30 kHz and the second sampling rate is of 20 kHz. For example, the first frequency range can be 15 kHz, and the second frequency range can be 10 kHz when the first sampling rate is of 30 kHz and the second sampling rate is of 20 kHz. In this example, the frequency components that are common to the first frequency-domain signal and the second frequency-domain can range frequencies up to 10 kHz.

In one or more example hearing aids, to determine the first processed signal comprises to apply a multi-channel processing technique to the first primary frequency-domain signal and the second frequency-domain signal. In one or more example hearing aids, the multi-channel processing technique comprises a beamforming technique.

In one or more example hearing aids, the first signal processing unit is configured to determine the first processed signal by performing a linear combination of the first primary frequency-domain signal and the second frequency-domain signal, thereby allowing for spatial filtering. For example, the first signal processing unit is configured to determine the first processed signal by, for a given frequency band, multiplying each of the first primary frequency-domain signal and the second frequency-domain signal by a constant and adding such signals together.

In one or more example hearing aids, to determine the first processed signal comprises to apply the multi-channel processing technique to the first primary frequency-domain signal, the second frequency-domain signal, the third frequency-domain signal, and the fourth frequency-domain signal. The first signal processing unit may be configured to determine the first processed signal by performing a linear combination of the first primary frequency-domain signal, the second frequency-domain signal, the third frequency-domain signal, and the fourth frequency-domain signal. For example, spatial filtering is applied to frequency components that are common to the plurality of frequency-domain signals (e.g., the first frequency-domain signal, the second frequency-domain, the third frequency-domain, the fourth frequency-domain signal).

In one or more example hearing aids, a beamforming technique comprises one or more of: a linear constraint minimum variance (LCMV) beamforming technique, a minimum variance distortionless response (MVDR) beamforming technique, a generalized sidelobe cancellation (GSC) technique, and any other suitable beamforming technique. Many beamforming technique variants can be found in literature.

For example, applying the multi-channel processing technique to the first primary frequency-domain signal and the second frequency-domain signal (e.g., or the first primary frequency-domain signal, the second frequency-domain signal, the third frequency-domain signal, and the fourth frequency-domain signal) can provide for spatial filtering of sounds from an environment of the hearing aid, and thereby enhancing a target acoustic source among a multitude of acoustic sources in the environment of the user wearing the hearing aid.

For example, applying a multi-channel processing technique to the first primary frequency-domain signal and the second frequency-domain signal (e.g., or the first primary frequency-domain signal, the second frequency-domain signal, the third frequency-domain signal, and the fourth frequency-domain signal) can comprise detecting (e.g., adaptively detecting) which direction a particular part of a microphone signal or a wireless signal originates from. The multi-channel processing technique may enable spatial attenuation of background noise sources.

For example, the MVDR beamforming technique can enable maintaining sound signals from a target direction (e.g., a look direction) unchanged, while attenuating sound signals from other directions maximally. For example, a generalized sidelobe cancellation (GSC) technique can be seen as an equivalent representation of an MVDR beamformer offering computational and numerical advantages over a direct implementation in its original form.

For example, directional processing can be achieved by linearly combining the plurality of input signals with one another. Hence, computational complexity may scale (e.g., linearly) with the number of frequency bands of the analysis filter banks (e.g., with the number of frequency components of the plurality of frequency components to be combined). For example, applying the multi-channel processing technique to the first primary frequency-domain signal and the second frequency-domain signal may require a lower processing capability when compared to applying such multi-channel processing technique to a plurality of frequency-domain signals associated with a frequency range comprising the first frequency range and the second frequency range (e.g., in comparison with directional processing over all frequency bands). Put differently, embodiments of the present disclosure may allow application of directional processing only to a subset of the full frequency range available to be used for signal processing, thus saving computations. In other words, a reduced computational complexity (e.g., improving battery life of the hearing aid) can be achieved by having only one digitized signal of the plurality of digitized signals associated with the highest sampling rate.

In one or more example hearing aids, the signal processing unit is configured to determine a first secondary frequency-domain signal based on the first frequency domain signal. In one or more example hearing aids, the first secondary frequency-domain signal is associated with the second frequency range. For example, the first secondary frequency-domain signal is associated with the second part of the set of first frequency components. The second frequency range (e.g., of the first secondary frequency-domain signal) may comprise a set of high frequency (HF) components. For example, the first secondary frequency-domain signal can be seen as the second frequency range of the first frequency-domain signal. Put differently, the first secondary frequency-domain signal may be associated with a set of NCF components, such as frequency components which are absent in the second frequency-domain signal, but present in the first frequency domain signal. The set of NCF components may be frequency components associated with the digitized signal sampled at the highest sampling rate.

In one or more example hearing aids, the signal processing unit comprises a second signal processing unit configured to determine a second processed signal based on the first secondary frequency-domain signal (e.g., the first frequency range of the first frequency-domain signal) and the first processed signal. In one or more example hearing aids, the second signal processing unit is configured to combine the second part of the set of first frequency components (e.g., the NCF components) of the first frequency-domain signal with a combined version of the first part of the set of first frequency components (e.g., the CF components) of the first frequency-domain signal with the set of second frequency components (e.g., the CF components) of the second frequency-domain signal. For example, combining the first secondary frequency-domain signal with the first processed signal comprises concatenating the second part of the set of first frequency components and the combined version of the first part of the set of first frequency components with the set of second frequency components. For example, combining the first secondary frequency-domain signal with the first processed signal comprises generating a vector comprising the combined version of the CF components of the first frequency-domain signal with the frequency components of the second frequency-domain signal and the NCF components of the second frequency-domain signal.

For example, the first processed signal can be seen as a combination of the first frequency range of the first frequency-domain signal with the first frequency range of the second frequency-domain signal. In other words, the first processed signal may be seen as a combination of the CF components of the first frequency-domain signal and of the second frequency domain signal. Optionally, the first processed signal is a signal resulting from a combination of the first frequency range of the first frequency-domain signal (e.g., the first part of the set of first frequency components), the second frequency-domain signal (e.g., the set of second frequency components), the third frequency domain signal (e.g., the set of third frequency components), and the fourth frequency-domain signal (e.g., the set of fourth frequency components). For example, the second processed signal can be seen as a frequency-domain signal associated with both the first frequency range and the second frequency range. The second processed signal may be a full band signal.

In one or more example hearing aids, the second signal processing unit is configured to determine a third processed signal based on the second processed signal. In one or more example hearing aids, to determine the third processed signal comprises to apply a single-channel processing technique to the second processed signal. For example, a single-channel processing technique can be construed as a signal processing technique to be applied to a single channel, such as to a full band signal. In one or more example hearing aids, the single-channel processing technique comprises one or more of: a noise reduction technique, a hearing loss compensation technique, a voice activity detection (VAD) technique, an own voice detection (OVD) technique, a feedback cancellation technique, and any other suitable single-channel processing technique.

In one or more example hearing aids, the single-channel processing technique is applied to all frequency bands of the third processed signal, e.g., to the full range of frequencies of the third processed signal. In other words, the third processed signal may be associated with a first frequency range (e.g., the first frequency range of the first frequency-domain signal and the frequency range second frequency-domain signal) and a second frequency range (e.g., the second frequency range of the first frequency-domain signal). The single-channel processing technique may be applied to the first frequency range and the second frequency range of the third processed signal.

It is an advantage of the present disclosure that, by having the second signal processing unit configured to combine the first processed signal (e.g., a combined version of the CF components of the first frequency-domain signal and the CF components of the second frequency-domain signal) with the first secondary frequency-domain signal (e.g., the NCF components of the first frequency-domain signal), a reduced computational complexity is achieved e.g., in terms of improving battery life of the hearing aid. In other words, by having the second signal processing unit configured to combine a first frequency range signal (e.g., with improved directionality) with a second frequency range signal (e.g., only comprising a subset of frequency components of the first frequency-domain signal, such as a set of NCF components), such second frequency range resulting from a higher sampling rate, a reduced computational complexity is achieved (in terms of improving battery life of the hearing aid), while delivering an audio signal with improved intelligibility and perception. Embodiments of the present disclosure may allow an increase in sound quality achieved from broader bandwidth processing, such as by combining the first processed signal with the first secondary frequency-domain signal.

For example, the computational complexity can scale with the sampling rate associated with the plurality of digitized signal, e.g., with the number of samples per second. For example, processing the NCF components of a subset of the plurality of digitized signals, such as of digitized signals associated with the highest sampling rate, can lead to a substantial save of computations.

For example, the second signal processing unit is configured to operate on 96 frequency bands when the first sampling rate is of 30 kHz and the second sampling rate is of 20 kHz. For example, the second signal processing unit is configured to operate on 96 frequency bands as the second signal processing unit is configured to determine the second processed signal by combining the first secondary frequency-domain signal (e.g., with 32 frequency bands, e.g., the NCF components) with the first processed signal (e.g., with 64 frequency bands, e.g., the CF components). The second processed signal may comprise 96 frequency components. For example, the first 64 frequency bands (e.g., frequency components) of the second processed signal are based on a linear combination between the plurality of digitized signals (e.g., the first digitized signal, the second digitized signal, the third digitized signal, the fourth digitized signal), and the last 32 frequency bands (e.g., frequency components) of the second processed signal are based on the first digitized signal, such as the digitized signal associated with the highest sampling rate. For example, the 96 frequency bands (e.g., frequency components) of the second processed signal may be further processed using a single-channel processing technique for (compressive) hearing loss compensation or noise reduction resulting in the third processing signal. The third processed signal may comprise 96 frequency components.

It is an advantage of the present disclosure that, by determining the third processed signal based on the first processed signal (e.g. the CF components of the plurality of digitized signals) and the second processed signal (e.g., the NCF components of the digitized signal associated with the highest sampling rate), improved sound quality is achieved while ensuring a reduced computational cost. Since the second signal processing unit is configured to jointly process the CF components of the plurality of digitized signals and the NCF components of the digitized signal (e.g., or of at least two digitized signals) associated the highest sampling rate, the overall computational cost imposed by the signal processing algorithms running on the hearing aid may be reduced, thereby saving battery power.

For example, an increase in the sampling rate of an audio signal can typically lead to a higher computational cost. Embodiments of the present disclosure may enable avoidance of excessive computations that would otherwise be needed if the second signal processing unit were configured to process the NCF components of all digitized signals provided by the input unit.

It is an advantage of the present disclosure that, by determining the third processed signal based on the first processed signal and the second processed signal, a reduced computational complexity may be reached without impairing speech intelligibility and perception of the output signal. Put differently, the third processed signal may be a signal with improved speech intelligibility and perception (e.g., with improved directionality, more resistant to noise sources, etc.)

In one or more example hearing aids, the signal processing unit comprises a synthesis filter configured to determine a processed signal based on the third processed signal. In one or hearing more example aids, the synthesis filter is configured to determine the processed signal by converting the third processed signal (e.g., a frequency-domain signal) to a time-domain signal. The processed signal may be a time-domain signal. In one or more examples, the synthesis filter is configured to operate on the highest sampling rate of the first and the second sampling rates. The synthesis filter may be configured to operate on the first sampling rate. In other words, the synthesis filter may be configured to provide the processed signal as a time-domain signal sampled at the first sampling rate.

For example, the third processed signal is converted into a 30 kHz digital time-domain signal, when the first sampling rate is of 30 kHz and the second sampling rate is of 20 kHz, in turn preserving frequencies up to 15 kHz. The upper frequencies of the third processed signal may be solely based on a single digitized signal.

Optionally, when the user of the hearing aid does not require to listen to the portion of the first digitized signal associated with NCF components, the synthesis filter can be configured to operate on the lowest sampling rate of the first and the second sampling rates. The synthesis filter may operate on the second sampling rate. For example, the synthesis filter is configured to determine the processed signal based on the first processed signal, e.g., based on the CF components of the plurality of frequency domain signals (e.g., the first frequency-domain signal, the second frequency domain signal, and one or more of the third frequency domain signal, and the fourth frequency domain signal). In one or more example hearing aids, the second processed signal may be used for signal analysis purposes, such as for OVD purposes.

For example, when the synthesis filter bank is not configured to support the NCF components of the signal sampled at the highest sampling rate, the hearing aid may only benefit from the NCF components of the signal sampled at the highest sampling rate in processing that may affect the CF components of the signal sampled at the highest sampling rate and the signals sampled at the lowest sampling rate. Such benefit may be achieved when using the NCF components of the signal sampled at the highest sampling rate and a combined version of the CF components of the of the signal sampled at the highest sampling rate and the frequency components of the signals sampled at the lowest sampling rate as input to a detector, e.g. one or more of a music detector, a sound scene classifier, a voice activity detector, an ultrasound detector, and an OVD.

For example, the output unit is configured to output, based on the processed signal, the audible signal.

In one or more example hearing aids, the input unit comprises a first analogue-to-digital (AD) conversion unit and a second AD conversion unit. In one or more example hearing aids, the first AD conversion unit is configured to digitize a first input signal using the first sampling rate for provision of the first digitized signal. In one or more example hearing aids, the second AD conversion unit being configured to digitize a second input signal using the second sampling rate for provision of the second digitized signal. In one or more example hearing aids, the input unit can further comprise a third AD conversion unit configured to digitize a third input signal using the third sampling rate for provision of the third digitized signal. In one or more example hearing aids, the input unit can further comprise a fourth AD conversion unit to digitize a fourth input signal using the fourth sampling rate for provision of the fourth digitized signal.

In one or more example hearing aids, an AD conversion unit is configured to digitize an analogue input signal (e.g., the first input signals, the second input signals, the third input signals, the fourth input signals) with a predefined sampling rate. For example, an analogue input signal can be converted to a digital audio signal in an AD conversion process, where the analogue input signal is sampled with a predefined sampling frequency or rate fₛ (fₛ being e.g., in the range from 8 kHz to 48 kHz) to provide digital (e.g., audio) samples x, (with n=1, . . . , N) at discrete points in time t, (with n=1, . . . , N), each digital (e.g., audio) sample representing the value of a respective electrical input signal at to by a predefined number N_{b} of bits (N_{b} being e.g., in the range from 1 to 48 bits, e.g., 24 bits). The sampling frequency or rate fₛ may be adapted to the particular needs of the application. For example, each digital (e.g., audio) sample is quantized using N_{b} bits (e.g., resulting in 2^{N}^{_{b}} different possible values of the digital sample). For example, a digital sample x, has a length in time of 1/fₛ (e.g., 50 μs for fₛ=20 kHz). A number of digital (e.g., audio) samples may be arranged in a time frame. A time frame may comprise 64 or 128 audio data samples. Other frame lengths may be used depending on the practical application. For example, each of the plurality of input signals (e.g., comprising the first input signal, the second input signal, and one or more of the third input signal, and the fourth input signal) comprises a number of digital samples arranged in a time frame. In other words, each of the plurality of electrical input signals comprises a plurality of frames.

Optionally, the plurality of AD conversion units (e.g., the first AD conversion unit, the second AD conversion unit, and one or more of the third AD conversion unit, and the fourth AD conversion unit) are included in an auxiliary device (e.g. a phone, a computer, etc.). The hearing aid may be configured to receive, from the auxiliary device, the first digitized signal sampled at the first sampling rate, the second digitized signal sampled at the second sampling rate, and one or more of the third digitized signal sampled, and the fourth digitized signal, with both being sampled at the second sampling rate.

In one or more example hearing aids, the input unit comprises an AD conversion unit configured to digitize the first input signal and the second input signal using a third sampling rate for provision of a first primary digitized signal and a second primary digitized signal. In one or more example hearing aids, the third sampling rate is different from the first sampling rate and the second sampling rate. In one or more example hearing aids, the third sampling rate is higher than the first sampling rate and the second sampling rate. In one or more example hearing aids, the AD conversion unit is configured to digitize a plurality of input signals (e.g., the first input signal, the second input signal, and one or more of the third input signal and the fourth input signal) using the third sampling rate for provision of a plurality of primary digitized signals (e.g., the first primary digitized signal, the second primary digitized signal, and one or more of the third primary digitized signal and the fourth primary digitized signal).

For example, the single AD conversion unit can be included in an auxiliary device (e.g. a phone, a computer, etc.). The hearing aid may be configured to receive, from the auxiliary device, the first digitized signal associate with the first sampling rate, the second digitized signal associated with the second sampling rate, and one or more of the third digitized signal sampled, and the fourth digitized signal, with both being both associated with the second sampling rate.

For example, an AD conversion unit may be included in an auxiliary device, the AD conversion unit being configured to transmitting a digital signal sampled at a first sampling rate or second sampling rate via the auxiliary device.

In one or more example hearing aids, each of the plurality of input signals (e.g., the first input signal, the second input signal, and one or more of the third input signal and the fourth input signal) can be sampled using the third sampling rate, such AD conversion unit being configured to provide a corresponding plurality of digital samples (e.g., a plurality of first digital samples, a plurality of second digital samples, and one or more of a plurality of third digital samples and a plurality of fourth digital samples). In one or more example hearing aids, to perform the AD conversion process comprises to apply an anti-aliasing filtering technique to each of the plurality of input signals. In other words, to provide the plurality of primary digitized signals (e.g., a plurality of filtered digital samples) may comprise to apply an anti-aliasing filtering technique to each of the plurality of input signals. The hearing aid may comprise an anti-aliasing LP filter for each input signal of the plurality of input signals.

In one or more example hearing aids, the input unit is configured to apply a downsampling technique to the first primary digitized signal and the second primary digitized signal when the third sampling rate is greater than the first sampling rate and the second sampling rate for provision of the first digitized signal and the second digitized signal. For example, the input unit is configured to apply the downsampling technique to the plurality of primary digitized signals (e.g., the first primary digitized signal, the second primary digitized signal, and one or more of the third primary digitized signal and the fourth primary digitized signal) for provision of the plurality of digitized signals (e.g., the first digitized signal, the second digitized signal, and one or more of the third digitized signal and the fourth digitized signal).

For example, the third sampling rate is much greater than the first sampling rate and the second sampling rate. For example, applying a downsampling technique to each of the plurality of primary digitized signals can comprise decimating each of the plurality of primary digitized signals by a factor. For example, the input unit is configured to provide the first digitized signal associated with a first sampling rate of 30 kHz when the third sampling rate is of 960 kHz and the first primary digitized signal is decimated by a factor of 32 (e.g., in order to achieve a first sampling rate of 30 kHz). For example, the input unit is configured to provide the second digitized signal associated with a second sampling rate of 20 kHz when the third sampling rate is of 960 kHz and the second primary digitized signal is decimated by a factor of 48 (e.g., in order to achieve a first sampling rate of 20 kHz).

In one or more example hearing aids, the input unit is configured to apply an upsampling technique to the first primary digitized signal and the second primary digitized signal when the third sampling rate is less than the first sampling rate and the second sampling rate for provision of the first digitized signal and the second digitized signal. For example, the input unit is configured to apply the upsampling technique to the plurality of primary digitized signals (e.g., the first primary digitized signal, the second primary digitized signal, and one or more of the third primary digitized signal and the fourth primary digitized signal) for provision of the plurality of digitized signals (e.g., the first digitized signal, the second digitized signal, and one or more of the third digitized signal and the fourth digitized signal). For example, the third sampling rate is much lower than the first sampling rate and the second sampling rate. For example, applying an upsampling technique to each of the plurality of primary digitized signals can comprise decimating each of the plurality of primary digitized signals by a factor.

In one or more example hearing aids, an AD conversion process can include sampling each of a plurality of input signals (e.g., first input signal, second input signal, third input signal, etc.) at a higher sampling rate or a lower sampling rate for provision a corresponding plurality of digital samples (e.g., first digital samples, second digital samples, third digital samples, etc.). In one or more example hearing aids, an AD conversion process can include applying a corresponding anti-aliasing filter LP filtering technique to each of the plurality of digital samples for provision of a corresponding plurality filtered digital samples (e.g., first filtered digital samples, second filtered digital samples, third filtered digital samples, etc.). In one or more example hearing aids, an AD conversion process can include applying a downsampling or upsampling technique to the each of the plurality of filtered digital samples for provision of a corresponding plurality of digitized signals (e.g., first digitized signal, second digitized signal, third digitized signal, etc.).

In one or more example hearing aids, at least one of the plurality of input signals can be sampled using at least two different sampling rates. For example, the hearing aid is configured to automatically switch between at least two sampling rates. In other words, an AD conversion unit may be configured to switch between at least two sampling rates. An AD conversion unit may be configured to sample a signal using a sampling rate retrieved from the memory of the hearing aid and/or an external device. The memory of the hearing aid and/or an external device may include at least two sampling rates that can be used by an AD conversion unit.

In one or more example hearing aids, the first input signal comprises a wireless signal or a microphone signal representative of a sound in an environment of the hearing aid. For example, the first input signal is a wireless signal. For example, the first input signal is a microphone signal (e.g., an electrical input signal). In one or more example hearing aids, the second input signal comprises a wireless signal or a microphone signal representative of a sound in the environment of the hearing aid. For example, the second input signal is a wireless signal. For example, the second input signal is a microphone signal (e.g., an electrical input signal). For example, the first input signal and the second input signal are microphone signals. For example, the first input signal and the second input signal are wireless signals. For example, the first input signal is a microphone signal, and the second input signal is a wireless signal. For example, the first input signal is a wireless signal, and the second input signal is a microphone signal.

In one or more example hearing aids, the input unit comprises one or more of a plurality of microphones and a wireless receiver (e.g., or a plurality of wireless receivers).

In one or more example hearing aids, a wireless signal can be a signal received by the hearing aid from an auxiliary device (e.g., a phone, a clip microphone, etc.). For example, a wireless signal can be seen as a digital audio signal, e.g., a streamed music signal which is already digitally sampled. An AD conversion unit comprised in the hearing aid may be configured to re-sample the digital audio signal to a preferred sampling rate, e.g., to the first sampling rate or the second sampling rate. For example, the wireless signal can be a signal sampled with a high sampling rate, e.g., a music signal. For example, when the input signal is obtained an external microphone or the contralateral hearing aid in respect to the hearing aid, the sampling rate of such input signal is preferably lower than the highest sampling rate that the hearing aid is configured to operate with. In other words, audio streaming applications (e.g., music) may benefit from a high sampling rate. On the other hand, a microphone signal (e.g., a binaurally transmitted microphone signal), which may be used for beamforming purposes, may not require to be sampling using such a high sampling rate.

For example, the plurality of microphones may be configured to provide a corresponding plurality of electrical input signals representing a sound in the environment of the hearing aid. Put differently, the input unit may comprise a plurality of input transducers (e.g., a plurality of microphones) configured to convert an input sound in an environment of the hearing aid to a corresponding plurality of electric input signals. For example, the plurality of microphones is configured to obtain a corresponding plurality of input signals. For example, the hearing aid may be configured to obtain the first input signal of the plurality of electrical input signals using a first microphone of the plurality of microphones. For example, the hearing aid is configured to obtain the second input signal of the plurality of electrical input signals using a second microphone of the plurality of microphones. For example, the hearing aid is configured to obtain a third input signal of the plurality of electrical input signals using a third microphone of the plurality of microphones. For example, the hearing aid is configured to obtain a fourth input signal of the plurality of electrical input signals using a fourth microphone of the plurality of microphones.

The wireless receiver may be configured to receive a wireless signal (e.g., a first input signal, a second input signal, a third input signal, a fourth input signal, etc.) comprising or representing a sound in the environment of the hearing aid. For example, the wireless receiver is configured to provide such wireless signal. In one or more example hearing aids, the wireless receiver is configured to receive an electromagnetic signal in the radio frequency range (e.g., 3 kHz to 300 GHz). In one or more example hearing aids, the wireless receiver may be configured to receive an electromagnetic signal in a frequency range of light (e.g., infrared light 300 GHz to 430 THz, or visible light, e.g., 430 THz to 770 THz).

In one or more example hearing aids, an input signal is indicative of a sound generated by the user of the hearing aid, people, or other sound sources in the environment of the hearing device. For example, an input signal may be indicative of user speech. For example, an input signal can comprise one or more of: the user's speech, interfering speech, echo, and noise (e.g., ambient noise, continuous noise, intermittent noise, impulsive noise, and/or low-frequency noise).

In one or more example hearing aids, the output unit comprises a digital-to-analogue (DA) conversion unit configured to convert the processed signal (e.g., a digital signal) to an analogue output signal, such as for being presented to the user wearing the hearing aid via the output unit. The output unit may be configured to output the audible signal based on the analogue output signal. The analogue output signal may be converted into an acoustic signal via the output transducer.

In one or more example hearing aids, the hearing aid comprises a ‘forward’ (or ‘signal’) path configured to process an audio signal between an input and an output of the hearing aid. In one or more example hearing aids, the signal processing unit is configured to apply one or more processing algorithms to the plurality of input signals, e.g., input signals of a forward path from the input to the output of the hearing aid, such as to the first input signal, the second input signal, and to one or more of: the third input signal and a fourth input signal, etc. The signal processing unit may be located in the forward path. The one or more processing algorithms may comprise a compression algorithm configured to amplify (e.g., or attenuate) a signal according to the needs of the user, e.g., to compensate for a hearing impairment of the user. Other processing algorithms may include frequency transposition, feedback control, etc. For example, the signal processing unit is configured to provide a frequency dependent gain and/or a level dependent compression and/or a transposition (with or without frequency compression) of one or more frequency ranges to one or more other frequency ranges, e.g., to compensate for a hearing impairment of a user. The signal processing unit may be configured to enhance the plurality of input signals and provide the processed signal.

The hearing aid may comprise an ‘analysis’ path comprising functional components configured to analyze signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

Most sound signal sources (except the user's own voice) are located far away from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (e.g., microphones) would be in the acoustic near-field of the sound source and a difference in level of the sound signals impinging on respective microphones may be significant. A typical distance for a communication partner is more than 1 m (>100 d_{mic}). The hearing aid (e.g., microphones) would be in the acoustic far-field of the sound source and a difference in level of the sound signals impinging on respective microphones is insignificant. The difference in time of arrival of sound impinging in the direction of the microphone axis (e.g., the front or back of a normal hearing aid) is ΔT=d_{mic}/v_{sound}=0.01/343 [s]=29 s, where v_{sound} is the speed of sound in air at 20° C. (343 m/s).

In one or more example hearing aids, the hearing aid comprises antenna and transceiver circuitry allowing a wireless link to an entertainment device (e.g., a TV-set), a communication device (e.g., a telephone), a wireless microphone, a separate (external) processing device, or another hearing aid, etc. The hearing aid may be configured to wirelessly receive a direct electric input signal (e.g., a wireless signal) from another device. Likewise, the hearing aid may be configured to wirelessly transmit a direct electric output signal (e.g., a wireless signal) to another device. The direct electric input or output signal may represent or comprise an audio signal and/or a control signal and/or an information signal.

A wireless link established by antenna and transceiver circuitry of the hearing aid may be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g., in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g., defined by the International Telecommunication Union, ITU). The wireless link may be based on a standardized or proprietary technology. The wireless link may be based on Bluetooth technology (e.g., Bluetooth Low-Energy technology, e.g. LE audio), or Ultra-Wideband (UWB) technology.

In one or more example hearing aids, the hearing aid can be constituted by or form part of a portable (e.g., configured to be wearable) device, such as a device comprising a local energy source, e.g., a battery (e.g., a rechargeable battery). The hearing aid may be a low weight, easily wearable, device, e.g., having a total weight less than 100 g, such as less than 20 g, such as less than 5 g.

The hearing aid may be configured to operate in different modes, e.g., a normal mode and one or more specific modes, e.g., selectable by a user, or automatically selectable. A mode of operation may be optimized to a specific acoustic situation or environment, e.g., a communication mode, such as a telephone mode. A mode of operation may include a low-power mode, where functionality of the hearing aid is reduced (e.g., to save power), e.g. to disable wireless communication, and/or to disable specific features of the hearing aid.

The hearing aid may comprise a number of detectors configured to provide status signals relating to a current physical environment of the hearing aid (e.g., the current acoustic environment), and/or to a current state of the user wearing the hearing aid, and/or to a current state or mode of operation of the hearing aid. Alternatively or additionally, one or more detectors may form part of an external device in communication (e.g., wirelessly) with the hearing aid. An external device may e.g. comprise another hearing aid, a remote control, and audio delivery device, a telephone (e.g., a smartphone), an external sensor, etc.

One or more of the number of detectors may operate on the full band signal (time domain). One or more of the number of detectors may operate on band split signals ((time-) frequency domain), e.g., in a limited number of frequency bands.

The number of detectors may comprise a level detector for estimating a current level of a signal of the forward path. The detector may be configured to decide whether the current level of a signal of the forward path is above or below a given (L-)threshold value. For example, the level detector operates on the full band signal (time domain). For example, the level detector operates on band split signals ((time-) frequency domain). For example, the level detector is configured to estimate the amount of gain in a given frequency band (e.g., component). Such amount of gain may depend on a current level of a signal of the forward path (e.g., compression). For example, the single-channel processing technique may comprise a level detection technique (e.g., performed by the level detector).

The hearing aid may comprise a VAD unit for estimating whether or not (or with what probability) an input signal comprises a voice signal (at a given point in time). For example, the VAD unit can be configured to apply a VAD technique to the first secondary frequency-domain signal. A voice signal may include a speech signal from a human being. It may also include other forms of utterances generated by the human speech system (e.g., singing). The VAD unit may be adapted to classify a current acoustic environment of the user as a VOICE or NO-VOICE environment. For example, such can be advantageous in the sense that the time segments of the electric microphone signal comprising human utterances (e.g., speech) in the user's environment can be identified, and thus separated from time segments only (or mainly) comprising other sound sources (e.g., artificially generated noise). The VAD unit may be configured to detect as a VOICE also the user's own voice. Alternatively, the VAD unit may be configured to exclude a user's own voice from the detection of a VOICE.

The hearing aid may comprise an OVD unit for estimating whether or not (or with what probability) a given input sound (e.g., a voice, e.g., speech) originates from the voice of the user of the system. For example, the OVD unit can be configured to apply a VOD technique to the first secondary frequency-domain signal. The hearing aid may be able to differentiate between a user's own voice and another person's voice and possibly from NON-voice sounds.

The number of detectors may comprise a movement detector, e.g., an acceleration sensor. The movement detector may be configured to detect movement of the user's facial muscles and/or bones, e.g., due to speech or chewing (e.g., jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g., including the current electromagnetic environment, e.g. the occurrence of electromagnetic signals (e.g., comprising audio and/or control signals) intended or not intended for reception by the hearing aid, or other properties of the current environment than acoustic);
b) the current acoustic situation (e.g., input level, feedback, etc.), and
c) the current mode or state of the user (e.g., movement, temperature, cognitive load, etc.);
d) the current mode or state of the hearing aid (e.g., program selected, time elapsed since last user interaction, etc.) and/or of another device in communication with the hearing aid.

The classification unit may be based on or comprise a neural network, e.g. a recurrent neural network, e.g. a trained neural network.

In one or more example hearing aids, the hearing aid comprises an acoustic (and/or mechanical) feedback control (e.g., suppression) or an echo-cancelling system. For example, the acoustic feedback control or the echo-cancelling system is configured to apply a feedback cancellation technique to the first secondary frequency-domain signal. For example, adaptive feedback cancellation allows tracking feedback path changes over time. It may be based on a linear time invariant filter to estimate the feedback path, with its filter weights being updated over time. The filter update may be calculated using stochastic gradient algorithms, such as a Least Mean Square (LMS) algorithm or a Normalized LMS (NLMS) algorithm. For example, such algorithms may enable minimization of the error signal in the mean square sense with the NLMS additionally normalizing the filter update with respect to the squared Euclidean norm of some reference signal.

In one or more example hearing aids, the hearing aid can further comprise other relevant functionality for the application in question, e.g. compression, noise reduction, etc.

In one or more example hearing aids, the hearing aid comprises a hearing instrument, e.g., a hearing instrument configured to be located at the ear or fully or partially in the ear canal of the user of the hearing aid.

### Use:

In an aspect, use of a hearing aid as described above, in the ‘detailed description of embodiments’ and in the claims, is moreover provided. Use may be provided in a system comprising one or more hearing aids (e.g., hearing instruments).

### A Method

A method of operating a hearing aid is disclosed herein. The method comprises providing a first digitized signal associated with a first sampling rate and a second digitized signal associated with a second sampling rate. The first digitized signal comprises a plurality of first frames (e.g., including a first primary frame), each of the plurality of first frames comprising a number of first samples. The second digitized signal comprises a plurality of second frames (e.g., including a second primary frame), each of the plurality of second frames comprising a number of second samples.

The method comprises determining the first sampling rate as being greater than the second sampling rate such that the time duration of each of the plurality of first frames is the same as the time duration of each of the plurality of second frames, thereby causing (e.g., enabling and/or allowing) the number of first samples to be greater than the number of second samples. In other words, the first sampling rate may be different from the second sampling rate such that the time duration of the first primary frame is the same as the time duration of the second primary frame.

The method comprises providing a first frequency-domain signal based on the first digitized signal, the first frequency-domain signal being associated with a first frequency range and a second frequency range. The method comprises providing a second frequency-domain signal based on the second digitized signal, the second frequency-domain signal being associated with the first frequency range. Determining the first and second sampling rates causes (e.g., allows and/or causes) the first frequency range of the first frequency-domain signal to comprise the same frequency bands as the second frequency-domain signal.

The method comprises determining a first processed signal based on the first frequency range of the first frequency-domain signal and the second frequency-domain signal. The method comprises outputting, based on the first processed signal, an audible signal to the user wearing the hearing aid.

It is intended that some or all of the structural features of the hearing aid described above, in the ‘detailed description of embodiments’ or in the claims can be combined with embodiments of the method, when appropriately substituted by a corresponding process and vice versa. Embodiments of the method have the same advantages as the corresponding hearing aid.

### a Computer Readable Medium or Data Carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

### A Computer Program:

A computer program (product) comprising instructions which, when the program is executed by a computer, cause the computer to carry out (steps of) the method described above, in the ‘detailed description of embodiments’ and in the claims is furthermore provided by the present application.

### a Data Processing System:

In an aspect, a data processing system comprising a processor and program code means for causing the processor to perform at least some (such as a majority or all) of the steps of the method described above, in the ‘detailed description of embodiments’ and in the claims is furthermore provided by the present application.

### A Hearing System:

In a further aspect, a hearing system comprising a hearing aid as described above, in the ‘detailed description of embodiments’, and in the claims, and an auxiliary device is moreover provided.

The hearing system may be adapted to establish a communication link between the hearing aid and the auxiliary device to provide that information (e.g., control and status signals, possibly audio signals) can be exchanged or forwarded from one to the other. The hearing system may be configured to perform the processing, e.g. ultrasound reduction, according to the present disclosure, fully or partially in a separate audio processing device.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g., from an entertainment device, e.g. a TV or a music player, a telephone apparatus, e.g. a mobile telephone or a computer, e.g., a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

### An APP:

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g., a smartphone, or on another portable device allowing communication with said hearing aid or said hearing system.

### Definitions

In the present context, a hearing aid, e.g., a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g., be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g., as a unit arranged behind the ear with a tube leading radiated acoustic signals into the ear canal or with an output transducer, e.g., a loudspeaker, arranged close to or in the ear canal, as a unit entirely or partly arranged in the pinna and/or in the ear canal. The hearing aid may comprise a single unit or several units communicating (e.g., acoustically, electrically or optically) with each other. The loudspeaker may be arranged in a housing together with other components of the hearing aid, or may be an external unit in itself (possibly in combination with a flexible guiding element, e.g., a dome-like element).

A hearing aid may be adapted to a particular user's needs, e.g., a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g., an audiogram, using a fitting rationale (e.g., adapted to speech). The frequency and level dependent gain may e.g., be embodied in processing parameters, e.g., uploaded to the hearing aid via an interface to a programming device (fitting system), and used by a processing algorithm executed by the configurable signal processing circuit of the hearing aid (e.g., the signal processing unit).

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g., a music player, a wireless communication device, e.g. a mobile phone (such as a smartphone) or a tablet or another device, e.g., comprising a graphical interface. Hearing aids, hearing systems or binaural hearing systems may e.g., be used for compensating for a hearing-impaired person's loss of hearing capability, augmenting or protecting a normal-hearing person's hearing capability and/or conveying electronic audio signals to a person. Hearing aids or hearing systems may e.g., form part of or interact with public-address systems, active ear protection systems, handsfree telephone systems, car audio systems, entertainment (e.g., TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1A-1B schematically illustrates an example first hearing aid according to the present disclosure,

FIG. 2A-2B schematically illustrates an example second hearing aid according to the present disclosure,

FIGS. 3A-3B schematically illustrate an example third hearing aid according to the present disclosure,

FIGS. 4A-4B schematically illustrate an example third hearing aid according to the present disclosure, and

FIG. 5 illustrates a flow-chart of an example method according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

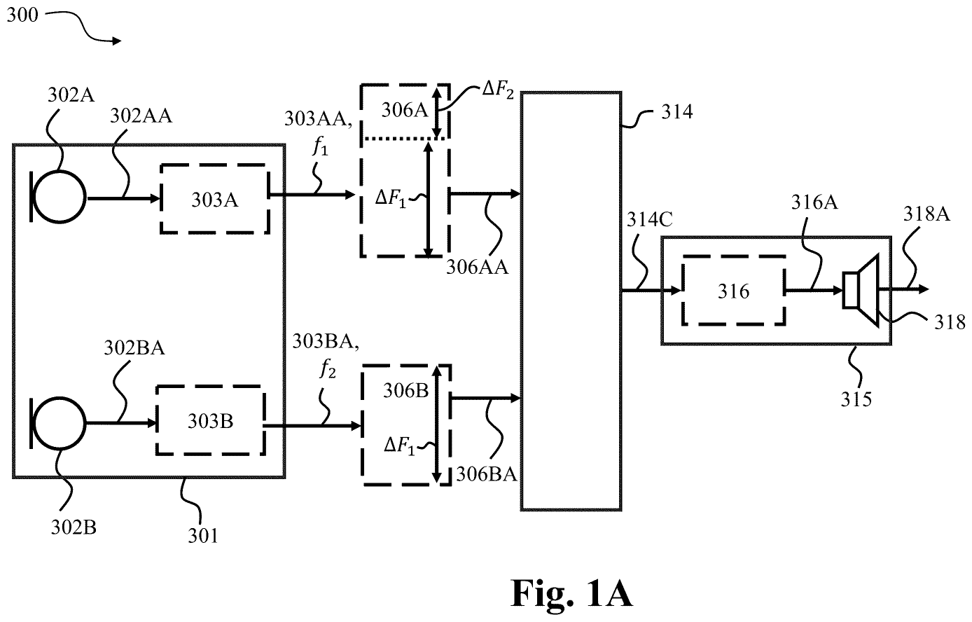

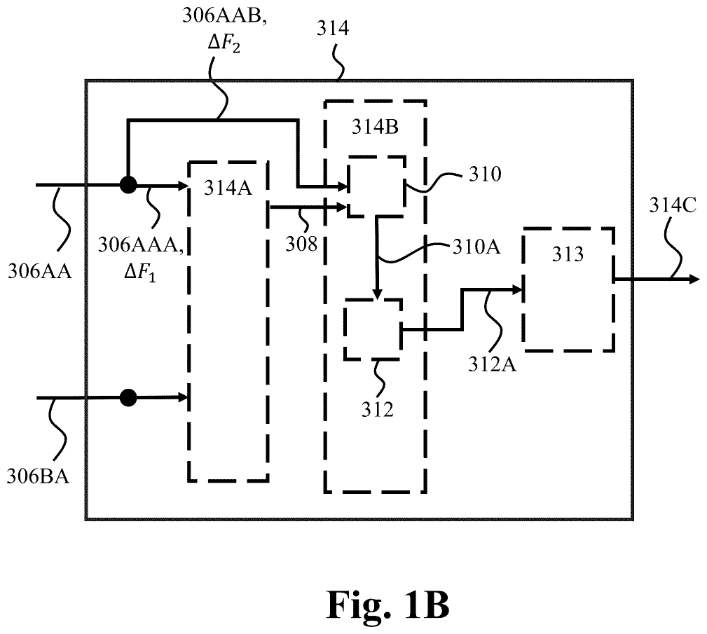

FIGS. 1A-1B schematically illustrates an example first hearing aid 300 according to the present disclosure. FIG. 1A shows the first hearing aid 300 comprising an input unit 301, a signal processing unit 314, and an output unit 315.

In the embodiment of FIG. 1A, the input unit 301 is configured to provide a first digitized signal 303AA associated with a first sampling rate f₁ and a second digitized signal 303BA associated with a second sampling rate f₂. The first digitized signal 303AA comprises a plurality of first frames, each of the plurality of first frames comprising a number of first samples. The second digitized signal 303BA comprises a plurality of second frames, each of the plurality of second frames comprising a number of second samples.

The hearing aid 300 (e.g., the input unit) is configured to determine the first sampling rate ft as being greater than (e.g., different to) the second sampling rate f₂ such that the time duration of each of the plurality of first frames is the same as the time duration of each of the plurality of second frames, thereby causing (e.g., allowing and/or enabling) the number of first samples to be greater than the number of second samples. In other words, the first sampling rate f₁ may be different from the second sampling rate f₂ such that the time duration of each of the plurality of first frames is the same as the time duration of each of the plurality of second frames.

In one or more example hearing aids, the input unit 301 comprises a plurality of microphones and a plurality of AD conversion units. In the embodiment of FIG. 1A, the plurality of microphones comprises a first microphone 302A and a second microphone 302B. In the embodiment of FIG. 1A, the plurality of AD conversion units comprises a first AD conversion unit 303A and a second AD conversion unit 303B.

In one or more example hearing aids, the first microphone 302A is configured to provide a first input signal 302AA. For example, the first input signal 302AA comprises a microphone signal representative of a sound in an environment of the first hearing aid 300. In other words, the first input signal 302AA may be seen as a microphone signal.

In one or more example hearing aids, the second microphone 302B is configured to provide a second input signal 302BA. For example, the second input signal 302BA comprises a microphone signal representative of the sound in the environment of the first hearing aid 300. In other words, the second input signal 302BA may be seen as a microphone signal.

Optionally, the input unit 301 can comprise a wireless receiver configured to receive the first input signal 302AA and/or the second input signal 302BA. The first input signal 302AA may be a wireless signal. The second input signal 302BA may be a wireless signal. The first input signal 302AA and the second input signal 302BA may be wireless signals.

In one or more example hearing aids, the first AD conversion unit 303A is configured to digitize the first input signal 302AA using the first sampling rate f₁ for provision of the first digitized signal 303AA. Put differently, the first AD conversion unit AD1 may be configured to provide the first digitized signal 303AA by sampling the first input signal 302AB at the first sampling rate f₁. In one or more examples, the second AD conversion unit 303B is configured to digitize the second input signal 302BA using the second sampling rate f₂ for provision of the second digitized signal 303BA. Put differently, the second AD conversion unit AD2 may be configured to provide the second digitized signal 303BA by sampling the second input signal 302BA at the second sampling rate f₂. For example, the first sampling rate f₁ is greater than the second sampling rate f₂.

Optionally, the first hearing aid 300 can comprise a single AD conversion unit (not shown in FIG. 1A) configured to digitize the first input signal 302AA and the second input signal 302BA using a third sampling rate for provision of a first primary digitized signal and a second primary digitized signal. In other words, the single AD conversion unit may be configured to sample the first input signal 302AA and the second input signal 302BA at the third sampling rate. For example, the third sampling rate is different from the first sampling rate f₁ and the second sampling rate f₂. For example, the input unit 301 is configured to apply a downsampling technique to the first primary digitized signal and the second primary digitized signal when the third sampling rate is greater than the first sampling rate f₁ and the second sampling rate f₂ for provision of the first digitized signal 303AA and the second digitized signal 303BA. For example, the input unit 301 is configured to apply an upsampling technique to the first primary digitized signal and the second primary digitized signal when the third sampling rate is less than the first sampling rate f₁ and the second sampling rate f₂ for provision of the first digitized signal 303AA and the second digitized signal 303BA.

Optionally, the first AD conversion unit 303A and the second AD conversion unit 303B (e.g. a phone, a computer, etc.) are included in an auxiliary device. The first hearing aid 300 may be configured to receive, from the auxiliary device, the first digitized signal 303AA sampled at the first sampling rate f₁ and the second digitized signal 303BA sampled at the second sampling rate f₂. For example, the single AD conversion unit can be included in an auxiliary device.

In one or more example hearing aids, the first hearing aid 300 comprises a plurality of analysis filter banks comprising a first analysis filter bank 306A and a second analysis filter bank 306B. Optionally, the input unit 301 can comprise the first analysis filter bank 306A and the second analysis filter bank 306B. For example, the first analysis filter bank 306A is configured to provide a first frequency-domain signal 306AA based on the first digitized signal 303AA. The first frequency-domain signal 306AA may be associated with a first frequency range ΔF₁ and a second frequency range ΔF₂. The first analysis filter bank 306A may be associated with a set of first frequency components. For example, a first part of such set of first frequency components can be seen as the first frequency range ΔF₁ of the first frequency-domain signal 306AA. For example, a second part of such set of first frequency components can be seen as the second frequency range ΔF₂ of the first frequency-domain signal 306AA. In one or more example hearing aids, the second analysis filter bank 306B is configured to provide a second frequency-domain signal 306BA based on the second digitized signal 303BA. The second frequency-domain signal 306BA may be associated with the first frequency range ΔF₁. The second analysis filter bank FB2 may be associated with a set of second frequency components. The set of second frequency components may be the same as the first part of the set of first frequency components. The frequency range of the second frequency-domain signal 306BA may be a subset of the frequency range of the first frequency-domain signal 306AA. In other words, the first sampling rate f₁ may be greater than the second sampling rate f₂.

For example, the signal processing unit 314 is configured determine a processed signal 314C based on the first digitized input signal 303AA and the second digitized input signal 303BA. For example, the signal processing unit 314 is configured determine the processed signal 314C based on the first frequency-domain signal 306AA and the second frequency-domain signal 306BA.

In one or more example hearing aids, the output unit 315 comprises a digital-to-analogue (DA) conversion unit 316 configured to convert the processed signal 314C (e.g., a digital signal) to an analogue output signal 316A, such as for being presented to the user wearing the first hearing aid 300 via the output unit OUT (e.g., output transducer 318, such as a loudspeaker).

In one or more example hearing aids, the output unit 315 is configured to output, based on the processed signal 314C, an audible signal 318A to the user wearing the first hearing aid 300. In the embodiment of FIG. 1A, the output unit 315 is configured to output the audible signal 318A based on the analogue output signal 316A. The analogue output signal 316A may be converted into an acoustic signal via the output transducer 318.

FIG. 1B shows the signal processing unit 314 of the first hearing aid 300. The signal processing unit 314 may comprise a first signal processing unit 314A and a second signal processing unit 314B.

In one or more example hearing aids, the signal processing unit 314 is configured to determine a first primary frequency-domain signal 306AAA based on the first frequency-domain signal 306AA. For example, the first primary frequency-domain signal 306AAA is associated with the first frequency range ΔF₁. In other words, the first primary frequency-domain signal 306AAA may indicate the first frequency-domain signal 306AA for the first frequency range ΔF₁. The second frequency-domain signal 306BA may indicate the second frequency-domain signal 306BA for the first frequency range ΔF₁, such as for the same set of frequency components as the first frequency-domain signal 306AA. The first frequency range ΔF₁ may comprise a set of CF components.

The first signal processing unit 314A (e.g., the signal processing unit 314) is configured to determine a first processed signal 308 based on the first primary frequency-domain signal 306AAA (e.g., the first frequency range of the first frequency-domain signal 306AA) and the second frequency-domain signal 306BA. In one or more example hearing aids, the first signal processing unit 314A is configured to determine the first processed signal 308 by applying a multi-channel processing technique to the first primary frequency-domain signal 306AAA and the second frequency-domain signal 306BA. The multi-channel processing technique may comprise a beamforming technique. In other words, the first signal processing unit 314A may be configured to combine the first primary frequency-domain signal 306AAA with the second frequency-domain signal 306BA in such a way that spatial filtering of sounds from the environment of the first hearing aid 300 is achieved.

In one or more example hearing aids, the signal processing unit 314 is configured to determine a first secondary frequency-domain signal 306AAB based on the first frequency-domain signal 306AA. For example, the first secondary frequency-domain signal 306AAB is associated with the second frequency range ΔF₂. The first secondary frequency-domain signal 306AB may indicate the first frequency-domain signal 306AA for the second frequency range ΔF₂, such as for the second part of the set of first frequency components. The second frequency range ΔF₂ may comprise a set of NCF components.

In one or more example hearing aids, the second signal processing unit 314B is configured to determine a second processed signal 310A based on the first secondary frequency-domain signal 306AAB and the first processed signal 308.

For example, the second signal processing unit 314B comprises a mixing unit 310 configured to determine the second processed signal 310A. The mixing unit 310 may be configured to combine the first processed signal 308 (e.g., a combination of the CF components of the first frequency-domain signal 306AA and of the second frequency domain signal 306BA) with the first secondary frequency-domain signal 306AAB (e.g., the NCF components of the first frequency-domain signal 306AA). For example, the mixing unit 310 can be seen as a merging unit configured to combine (e.g., concatenate) the NCF components of the first frequency-domain signal 306AA and a combined version of the CF components of the first frequency-domain signal 306AA and the frequency components of the second frequency domain signal 306BA into a joint vector. The second processed signal 310A may be seen as a joint vector. For example, the second processed signal 310A is a frequency-domain signal, e.g., a full band signal.

For example, the second signal processing unit 314B is configured to determine the third processed signal 312A based on the second processed signal 310A. For example, the second signal processing unit 314B is configured to determine the third processed signal 312A by applying a single-channel processing technique to the second processed signal 310A. For example, the second signal processing unit 314B comprises a single-channel processing unit 312 configured to apply the single-channel processing technique to the second processed signal 310A. The single-channel processing technique may comprise one or more of: a noise reduction technique, a hearing loss compensation technique, a VAD technique, an OVD technique, a feedback cancellation technique, and any other suitable single-channel processing technique. The third processed signal 312A may be a frequency-domain signal, e.g., a full band signal further processed for one or more of: noise reduction, hearing loss compensation, VAD, OVD, and feedback cancellation.

In one or more example hearing aids, the signal processing unit 314 comprises a synthesis filter 313 configured to determine the processed signal 314C based on the third processed signal 312A. For example, the synthesis filter 313 is configured to determine the processed signal 314C by converting the third processed signal 312A to a time-domain signal. The processed signal 314C may be a time-domain signal. For example, the synthesis filter 313 is configured to operate on the highest sampling rate among the first sampling rate f₁ and the second sampling rate f₂, such as on the first sampling rate f₁.

FIGS. 1A-1B may illustrate a hearing aid comprising a first microphone and a second microphone, in which the first input signal provided by the first microphone is sampled at a higher sampling rate (e.g., at the first sampling rate f₁) than the sampling rate of the second input signal provided by the second microphone. It is an advantage of the present disclosure that, by having the first input signal sampled at a sampling rate greater than the sampling rate of the second input signal, a reduced computational complexity can be achieved when the hearing aid operates at higher sampling rates, in turn improving battery performance.

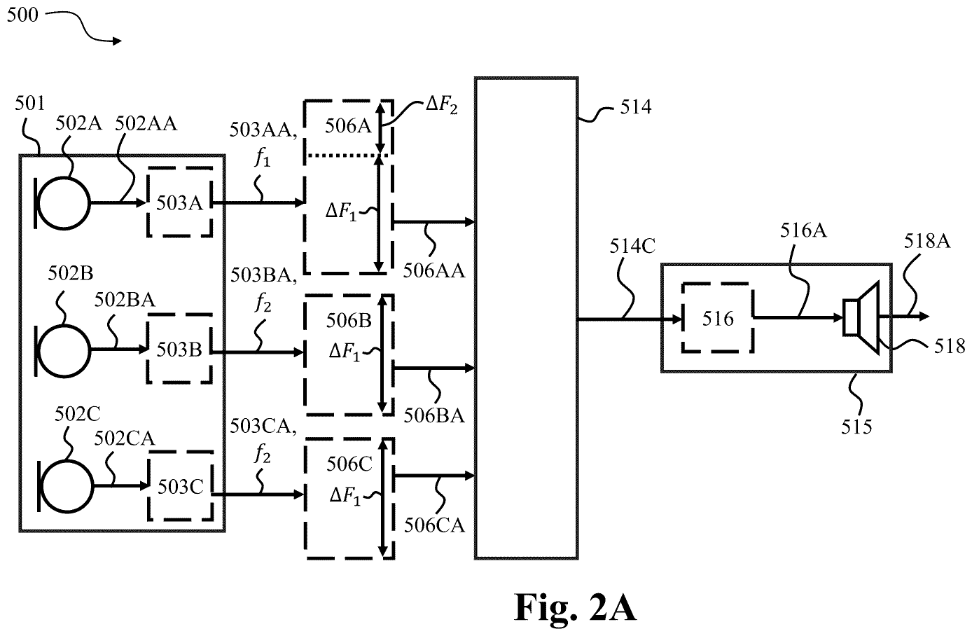

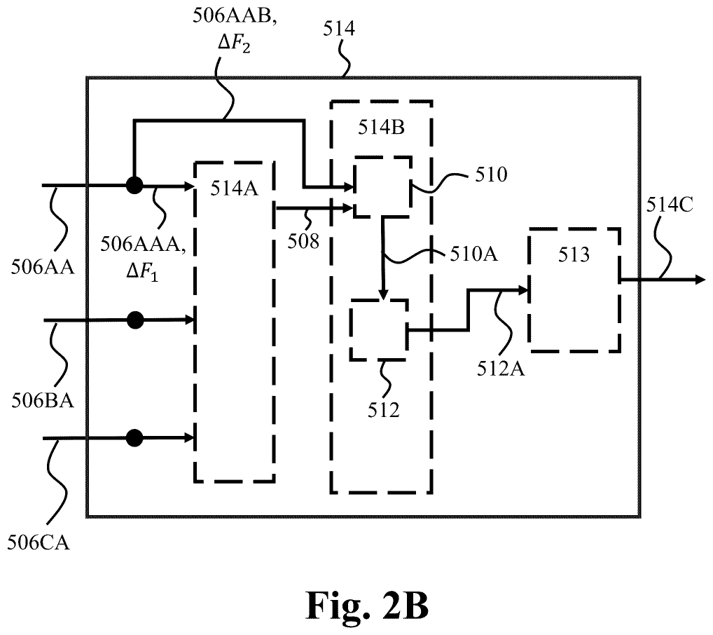

FIGS. 2A-2B schematically illustrates an example second hearing aid 500 according to the present disclosure. FIG. 2A shows the second hearing aid 500 comprising an input unit 501, a signal processing unit 514, and an output unit 515.

In the embodiment of FIG. 2A, the input unit 501 is configured to provide a first digitized signal 503AA associated with a first sampling rate f₁, a second digitized signal 503BA associated with a second sampling rate f₂, and a third digitized signal 503CA associated with the second sampling rate f₂. The first digitized signal 503AA comprises a plurality of first frames, each of the plurality of first frames comprising a number of first samples. The second digitized signal 503BA comprises a plurality of second frames, each of the plurality of second frames comprising a number of second samples. The third digitized signal 503CA comprises a plurality of third frames, each of the plurality of third frames comprising a number of third samples.

The hearing aid 500 (e.g., the input unit) is configured to determine the first sampling rate ft as being greater than (e.g., different to) the second sampling rate f₂ such that the time duration of each of the plurality of first frames is the same as the time duration of each of the plurality of second frames and as the time duration of each of the plurality of third frames, thereby causing (e.g., allowing and/or enabling) the number of first samples to be greater than the number of second and third samples. In other words, the first sampling rate f₁ may be different from the second sampling rate f₂ such that the time duration of each of the plurality of first frames is the same as the time duration of each of the plurality of second frames and of each of the plurality of third frames.

In one or more example hearing aids, the input unit 501 comprises a plurality of microphones and a plurality of AD conversion units. In the embodiment of FIG. 2A, the plurality of microphones comprises a first microphone 502A, a second microphone 502B, and a third microphone 502C. In the embodiment of FIG. 2A, the plurality of AD conversion units comprises a first AD conversion unit 503A, a second AD conversion unit 503B, and a third conversion unit 503C.

In one or more example hearing aids, the first microphone 502A is configured to provide a first input signal 502AA. For example, the first input signal 502AA comprises a microphone signal representative of a sound in an environment of the second hearing aid 500. In other words, the first input signal 502AA may be seen as a microphone signal.

In one or more example hearing aids, the second microphone 502B is configured to provide a second input signal 502BA. For example, the second input signal 502BA comprises a microphone signal representative of the sound in the environment of the second hearing aid 500. In other words, the second input signal 502BA may be seen as a microphone signal.

In one or more example hearing aids, the third microphone 502C is configured to provide a third input signal 502CA. For example, the third input signal 502CA comprises a microphone signal representative of the sound in the environment of the second hearing aid 500. In other words, the third input signal 502CA may be seen as a microphone signal.

Optionally, the input unit 501 can comprise a wireless receiver configured to receive one or more of: the first input signal 502AA, the second input signal 502BA, and the third input signal 502CA. The first input signal 502AA may be a wireless signal. The second input signal 502BA may be a wireless signal. The third input signal 502CA may be a wireless signal.

In one or more example hearing aids, the first AD conversion unit 503A is configured to digitize the first input signal 502AA using the first sampling rate f₁ for provision of the first digitized signal 503AA. Put differently, the first AD conversion unit 503A may be configured to provide the first digitized signal 503AA by sampling the first input signal 502AA at the first sampling rate f₁. In one or more examples, the second AD conversion unit 503B is configured to digitize the second input signal 502BA using the second sampling rate f₂ for provision of the second digitized signal 503BA. Put differently, the second AD conversion unit 503B may be configured to provide the second digitized signal 503BA by sampling the second input signal 502BA at the second sampling rate f₂. In one or more examples, the third AD conversion unit 503C is configured to digitize the third input signal 502CA using the second sampling rate f₂ for provision of the third digitized signal 503CA. Put differently, the third AD conversion unit 503C may be configured to provide the third digitized signal 503CA by sampling the third input signal 502CA at the second sampling rate f₂. For example, the first sampling rate f₁ is greater than the second sampling rate f₂.

Optionally, the second hearing aid 500 can comprise a single AD conversion unit (not shown in FIG. 2A) configured to digitize the first input signal 502AA, the second input signal 502BA, and the third input signal 502CA using a third sampling rate for provision of a first primary digitized signal, a second primary digitized signal, and a third primary digitized signal. In other words, the single AD conversion unit may be configured to sample the first input signal 502AA, the second input signal 502BA, and the third input signal 502CA at the third sampling rate. For example, the third sampling rate is different from the first sampling rate f₁ and the second sampling rate f₂. For example, the input unit 501 is configured to apply a downsampling technique to the first primary digitized signal, the second primary digitized signal, and the third primary digitized signal when the third sampling rate is greater than the first sampling rate f₁ and the second sampling rate f₂ for provision of the first digitized signal 503AA, the second digitized signal 503BA, and the third digitized signal 503CA. For example, the input unit 501 is configured to apply an upsampling technique to the first primary digitized signal, the second primary digitized signal, and the third primary digitized signal when the third sampling rate is less than the first sampling rate f₁ and the second sampling rate f₂ for provision of the first digitized signal 503AA, the second digitized signal 503BA, and the third digitized signal 503CA.

Optionally, the first AD conversion unit 503A and the second AD conversion unit 503B (e.g. a phone, a computer, etc.) are included in an auxiliary device. The second hearing aid 500 may be configured to receive, from the auxiliary device, the first digitized signal 503AA sampled at the first sampling rate f₁, the second digitized signal 503BA sampled at the second sampling rate f₂, and the third digitized signal 503BA sampled at the second sampling rate f₂. For example, the single AD conversion unit can be included in an auxiliary device.

In one or more example hearing aids, the second hearing aid 500 comprises a plurality of analysis filter banks comprising a first analysis filter bank 506A, a second analysis filter bank 506B, and a third analysis filter bank 506C. Optionally, the input unit 501 can comprise the first analysis filter bank 506A, the second analysis filter bank 506B, and the third analysis filter bank 506C. For example, the first analysis filter bank 506A is configured to provide a first frequency-domain signal 506AA based on the first digitized signal 503AA. The first frequency-domain signal 506AA may be associated with a first frequency range ΔF₁ and a second frequency range ΔF₂. The first analysis filter bank 506A may be associated with a set of first frequency components. For example, a first part of such set of first frequency components can be seen as the first frequency range ΔF₁ of the first frequency-domain signal 506AA. For example, a second part of such set of first frequency components can be seen as the second frequency range ΔF₂ of the first frequency-domain signal 506A.

In one or more example hearing aids, the second analysis filter bank 506B is configured to provide a second frequency-domain signal 506BA based on the second digitized signal 503BA. The second frequency-domain signal 506BA may be associated with the first frequency range ΔF₁. The second analysis filter bank 506B may be associated with a set of second frequency components. In one or more example hearing aids, the third analysis filter bank 506C is configured to provide a third frequency-domain signal 506CA based on the third digitized signal 503CA. The third frequency-domain signal 506CA may be associated with the first frequency range ΔF₁. The third analysis filter bank 506C may be associated with a set of third frequency components. The set of second frequency components and the set of third frequency components may be the same as the first part of the set of first frequency components. The set of second frequency components may be the same as the set of third frequency components. The frequency range of the second frequency-domain signal 506BA and the third frequency-domain signal 506CA may be a subset of the frequency range of the first frequency-domain signal 506AA. In other words, the first sampling rate f₁ may be greater than the second sampling rate f₂.

For example, the signal processing unit 514 is configured determine a processed signal 514C based on the first digitized input signal 503AA, the second digitized input signal 503BA, and the third digitized input signal 503CA. For example, the signal processing unit 514 is configured determine the processed signal 514C based on the first frequency-domain signal 506AA, the second frequency-domain signal 506BA, and the third frequency-domain signal 506CA.

In one or more example hearing aids, the output unit 515 comprises a DA conversion unit 516 configured to convert the processed signal 514C (e.g., a digital signal) to an analogue output signal 516A, such as for being presented to the user wearing the second hearing aid 500 via the output unit 515 (e.g., output transducer 518, such as a loudspeaker).

In one or more example hearing aids, the output unit 515 is configured to output, based on the processed signal 514C, an audible signal 518A to the user wearing the second hearing aid 500. In the embodiment of FIG. 2A, the output unit 515 is configured to output the audible signal 518A based on the analogue output signal 516A. The analogue output signal 516A may be converted into an acoustic signal via the output transducer 518.

FIG. 2B shows the signal processing unit 514 of the second hearing aid 300. The signal processing unit 514 may comprise a first signal processing unit 514A and a second signal processing unit 514B.

In one or more example hearing aids, the signal processing unit 514 is configured to determine a first primary frequency-domain signal 506AAA based on the first frequency-domain signal 506AA. For example, the first primary frequency-domain signal 506AAA is associated with the first frequency range ΔF₁. In other words, the first primary frequency-domain signal 506AAA may indicate the first frequency-domain signal 506AA for the first frequency range ΔF₁. The second frequency-domain signal 506BA may indicate the second frequency-domain signal 506BA for the first frequency range ΔF₁, such as for the same set of frequency components as the first frequency-domain signal 506AA. The third frequency-domain signal 506CA may indicate the third frequency-domain signal 506CA for the first frequency range ΔF₁, such as for the same set of frequency components as the first frequency-domain signal 506AA. The first frequency range ΔF₁ may comprise a set of CF components.

The first signal processing unit 514A (e.g., the signal processing unit 514) is configured to determine a first processed signal 508 based on the first primary frequency-domain signal 506AAA (e.g., the first frequency range of the first frequency-domain signal 506AA), the second frequency-domain signal 506BA and the third frequency-domain signal 506CA. In one or more example hearing aids, the first signal processing unit 514A is configured to determine the first processed signal 508 by applying a multi-channel processing technique to the first primary frequency-domain signal 506AAA, the second frequency-domain signal 506BA and the third frequency-domain signal 506CA.

The multi-channel processing technique may comprise a beamforming technique. In other words, the first signal processing unit 514A may be configured to combine the first primary frequency-domain signal 506AAA, the second frequency-domain signal 506BA and the third frequency-domain signal 506CA with each other, in such away that spatial filtering of sounds from the environment of the second hearing aid 500 is achieved.

In one or more example hearing aids, the signal processing unit 514 is configured to determine a first secondary frequency-domain signal 506AAB based on the first frequency-domain signal 506AA. For example, the first secondary frequency-domain signal 506AAB is associated with the second frequency range ΔF₂. The first secondary frequency-domain signal 506AAB may indicate the first frequency-domain signal 506AA for the second frequency range ΔF₂, such as for the second part of the set of first frequency components. The second frequency range ΔF₂ may comprise a set of NCF components.

In one or more example hearing aids, the second signal processing unit 514B is configured to determine a second processed signal 510A based on the first secondary frequency-domain signal 506AAB and the first processed signal 508.

For example, the second signal processing unit 314B comprises a mixing unit 510 configured to determine the second processed signal 510A. The mixing unit 512 may be configured to combine the first processed signal 508 (e.g., a combination of the CF components of the first frequency-domain signal 506AA and of the second frequency domain signal 506BA, and the third frequency-domain signal 506CA) with the first secondary frequency-domain signal 506AAB (e.g., the NCF components of the first frequency-domain signal 506AA). For example, the mixing unit 310 can be seen as a merging unit configured to combine (e.g., concatenate) the NCF components of the first frequency-domain signal 506AA and a combined version of the CF components of the first frequency-domain signal 506AA and the frequency components of the second frequency domain signal 506BA into a joint vector. The second processed signal 510A may be seen as a joint vector. For example, the second processed signal 510A is a frequency-domain signal, e.g., a full band signal.

For example, the second signal processing unit 514B is configured to determine the third processed signal 512A based on the second processed signal 510A. For example, the second signal processing unit 514B is configured to determine the third processed signal 512A by applying a single-channel processing technique to the second processed signal 510A. For example, the second signal processing unit 514B comprises a single-channel processing unit 512 configured to apply the single-channel processing technique to the second processed signal 510A. The single-channel processing technique may comprise one or more of: a noise reduction technique, a hearing loss compensation technique, a VAD technique, an OVD technique, a feedback cancellation technique, and any other suitable single-channel processing technique. The third processed signal 512A may be a frequency-domain signal, e.g., a full band signal further processed for one or more of: noise reduction, hearing loss compensation, VAD, OVD, and feedback cancellation.

In one or more example hearing aids, the signal processing unit 514 comprises a synthesis filter 514 configured to determine the processed signal 514C based on the third processed signal 512A. For example, the synthesis filter 513 is configured to determine the processed signal 514C by converting the third processed signal 512A to a time-domain signal. The processed signal 514C may be a time-domain signal. For example, the synthesis filter 513 is configured to operate on the highest sampling rate among the first sampling rate f₁ and the second sampling rate f₂, such as on the first sampling rate f₁. The third processed signal 513 may be synthesized back into a time domain signal sampled at the first sampling frequency f₁.

FIGS. 2A-2B may illustrate a hearing aid comprising a first microphone, a second microphone, and a third microphone, in which the first input signal provided by the first microphone is sampled at a higher sampling rate (e.g., at the first sampling rate f₁) than the sampling rate of the second input signal provided by the second microphone and the sampling rate of the third input signal provided by the third microphone. It is an advantage of the present disclosure that, by having the first input signal sampled at a sampling rate greater than the sampling rate of the second input signal and the third input signal, a reduced computational complexity can be achieved when the hearing aid operates at higher sampling rates, in turn improving battery performance.

For example, the CF components of the first frequency-domain signal 506AA, the second frequency-domain signal 506BA, and the third frequency-domain signal 506CA can be combined with each other, such as frequency components up to f₂/2 (e.g., below the Nyquist frequency), in turn allowing for directional processing. For frequencies components between f₂/2 and f₁/2, the processed signal 514C is solely based on the first input signal 502AA (e.g., the first digitized signal 503AA, the first frequency-domain signal 506AA). For frequencies components up to f₂/2, the processed signal 514C is based on the first input signal 502AA (e.g., the first digitized signal 503AA, the first frequency-domain signal 506AA), the second input signal 502BA (e.g., the second digitized signal 503BA, the second frequency-domain signal 506BA), and the third input signal 502CA (e.g., the third digitized signal 503CA, the third frequency-domain signal 506CA),

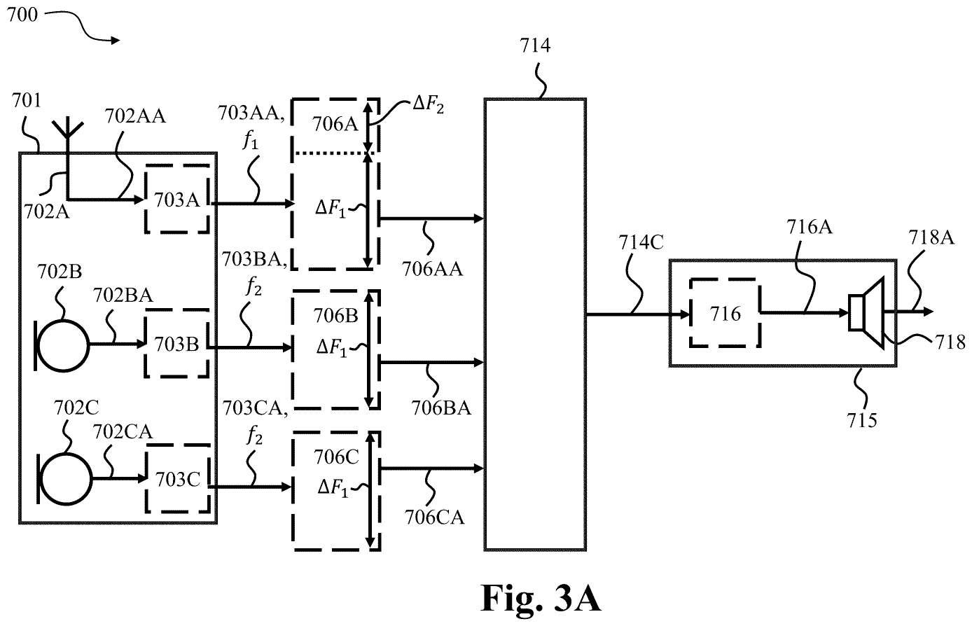

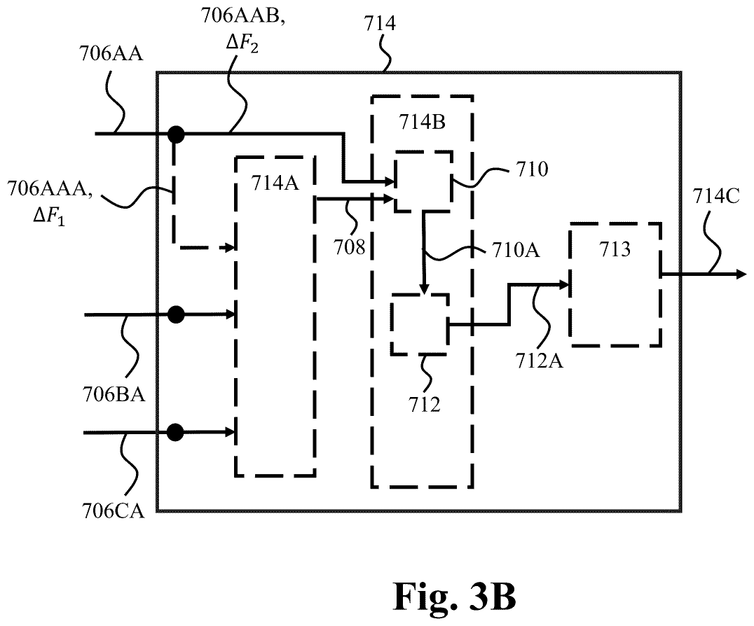

FIGS. 3A-3B schematically illustrates an example third hearing aid 700 according to the present disclosure. FIG. 3A shows the third hearing aid 700 comprising an input unit 701, a signal processing unit 714, and an output unit 715.

In the embodiment of FIG. 3A, the input unit 701 is configured to provide a first digitized signal 703AA associated with a first sampling rate f₁, a second digitized signal 703BA associated with a second sampling rate f₂, and a third digitized signal 703CA associated with the second sampling rate f₂. The first digitized signal 703AA comprises a plurality of first frames, each of the plurality of first frames comprising a number of first samples. The second digitized signal 703BA comprises a plurality of second frames, each of the plurality of second frames comprising a number of second samples. The third digitized signal 703CA comprises a plurality of third frames, each of the plurality of third frames comprising a number of third samples.

The hearing aid 700 (e.g., the input unit) is configured to determine the first sampling rate f₁ as being greater than (e.g., different to) the second sampling rate f₂ such that the time duration of each of the plurality of first frames is the same as the time duration of each of the plurality of second frames and as the time duration of each of the plurality of third frames, thereby causing (e.g., allowing and/or enabling) the number of first samples to be greater than the number of second and third samples. In other words, the first sampling rate f₁ may be different from the second sampling rate f₂ such that the time duration of each of the plurality of first frames is the same as the time duration of each of the plurality of second frames and of each of the plurality of third frames.

In one or more example hearing aids, the input unit 701 comprises a plurality of microphones, a wireless receiver 702A (e.g., a wireless transceiver), and a plurality of AD conversion units. In the embodiment of FIG. 2A, the plurality of microphones comprises a first microphone 702B and a second microphone 702C. In the embodiment of FIG. 2A, the plurality of AD conversion units comprises a first AD conversion unit 703A, a second AD conversion unit 703B, and a third conversion unit 703C.

In one or more example hearing aids, the wireless receiver 702A is configured to receive a first input signal 702AA. For example, the first input signal 702AA comprises a wireless signal representative of a sound in an environment of the second hearing aid 500. In other words, the first input signal 702AA may be seen as a wireless signal. In the embodiment of FIG. 3A, the first input signal 702AA is a streamed audio signal, such as a music signal.

In one or more example hearing aids, the first microphone 702B is configured to provide a second input signal 702BA. For example, the second input signal 702BA comprises a microphone signal representative of the sound in the environment of the third hearing aid 700. In other words, the second input signal 702BA may be seen as a microphone signal.

In one or more example hearing aids, the second microphone 702C is configured to provide a third input signal 702CA. For example, the third input signal 702CA comprises a microphone signal representative of the sound in the environment of the third hearing aid 700. In other words, the third input signal 702CA may be seen as a microphone signal.

In one or more example hearing aids, the first AD conversion unit 703A is configured to digitize the first input signal 702AA using the first sampling rate f₁ for provision of the first digitized signal 703AA. Put differently, the first AD conversion unit 703A may be configured to provide the first digitized signal 703AA by sampling the first input signal 702AA at the first sampling rate f₁. The first input signal 702AA may be an already digitally sampled signal at a sampling rate different from the first sampling rate f₁. The first AD conversion unit 703A may be configured to re-sample the first input signal 702AA in such a way that the first digitized signal is associated with the first sampling rate f₁. In one or more examples, the second AD conversion unit 703B is configured to digitize the second input signal 702BA using the second sampling rate f₂ for provision of the second digitized signal 703BA. Put differently, the second AD conversion unit 703B may be configured to provide the second digitized signal 703BA by sampling the second input signal 702BA at the second sampling rate f₂. In one or more examples, the third AD conversion unit 703C is configured to digitize the third input signal 702CA using the second sampling rate f₂ for provision of the third digitized signal 703CA. Put differently, the third AD conversion unit AD3 may be configured to provide the third digitized signal 703CA by sampling the third input signal 702CA at the second sampling rate f₂. For example, the first sampling rate f₁ is greater than the second sampling rate f₂.

Optionally, the third hearing aid 700 can comprise a single AD conversion unit (not shown in FIG. 3A) configured to digitize the first input signal 702AA, the second input signal 702BA, and the third input signal 702CA using a third sampling rate for provision of a first primary digitized signal, a second primary digitized signal, and a third primary digitized signal. In other words, the single AD conversion unit may be configured to sample the first input signal 702AA, the second input signal 702BA, and the third input signal 702CA at the third sampling rate. For example, the third sampling rate is different from the first sampling rate f₁ and the second sampling rate f₂. For example, the input unit 701 is configured to apply a downsampling technique to the first primary digitized signal, the second primary digitized signal, and the third primary digitized signal when the third sampling rate is greater than the first sampling rate f₁ and the second sampling rate f₂ for provision of the first digitized signal 703AA, the second digitized signal 703BA, and the third digitized signal 703CA. For example, the input unit 701 is configured to apply an upsampling technique to the first primary digitized signal, the second primary digitized signal, and the third primary digitized signal when the third sampling rate is less than the first sampling rate f₁ and the second sampling rate f₂ for provision of the first digitized signal 703AA, the second digitized signal 703BA, and the third digitized signal 703CA.

In one or more example hearing aids, the third hearing aid 700 comprises a plurality of analysis filter banks comprising a first analysis filter bank 706A, a second analysis filter bank 706B, and a third analysis filter bank 706C. Optionally, the input unit 701 can comprise the first analysis filter bank 706A, the second analysis filter bank 706B, and the third analysis filter bank 706C. For example, the first analysis filter bank 706A is configured to provide a first frequency-domain signal 706AA based on the first digitized signal 703AA. The first frequency-domain signal 706AA may be associated with a first frequency range ΔF₁ and a second frequency range ΔF₂. The first analysis filter bank 706A may be associated with a set of first frequency components. For example, a first part of such set of first frequency components can be seen as the first frequency range ΔF₁ of the first frequency-domain signal 706AA. For example, a second part of such set of first frequency components can be seen as the second frequency range ΔF₂ of the first frequency-domain signal 706AA. In one or more example hearing aids, the second analysis filter bank 706B is configured to provide a second frequency-domain signal 706BA based on the second digitized signal 703BA. The second frequency-domain signal 706BA may be associated with the first frequency range ΔF₁. The second analysis filter bank 706BA may be associated with a set of second frequency components.

In one or more example hearing aids, the third analysis filter bank 706C is configured to provide a third frequency-domain signal 706CA based on the third digitized signal 703CA. The third frequency-domain signal 706CA may be associated with the first frequency range ΔF₁. The third analysis filter bank 706C may be associated with a set of third frequency components. The set of second frequency components and the set of third frequency components may be the same as the first part of the set of first frequency components. The set of second frequency components may be the same as the set of third frequency components. The frequency range of the second frequency-domain signal 706BA and the third frequency-domain signal 706CA may be a subset of the frequency range of the first frequency-domain signal 706AA. The frequency range of the second frequency-domain signal 706BA may be a subset of the frequency range of the first frequency-domain signal 706AA. The frequency range of the third frequency-domain signal 706CA may be a subset of the frequency range of the first frequency-domain signal 706AA. In other words, the first sampling rate f₁ may be greater than the second sampling rate f₂.

For example, the signal processing unit 714 is configured determine a processed signal 714C based on the first digitized input signal 703AA, the second digitized input signal 703BA, and the third digitized input signal 703CA.

In one or more example hearing aids, the output unit 715 comprises a DA conversion unit 716 configured to convert the processed signal 714C (e.g., a digital signal) to an analogue output signal 716A, such as for being presented to the user wearing the third hearing aid 700 via the output unit 715 (e.g., output transducer 718, such as a loudspeaker).

In one or more example hearing aids, the output unit 715 is configured to output, based on the processed signal 714C, an audible signal 718A to the user wearing the third hearing aid 700. In the embodiment of FIG. 3A, the output unit 715 is configured to output the audible signal 718A based on the analogue output signal 716A. The analogue output signal 716A may be converted into an acoustic signal via the output transducer 718.

FIG. 3B shows the signal processing unit 714 of the third hearing aid 700. The signal processing unit 714 may comprise a first signal processing unit 714C and a second signal processing unit 714B.

In one or more example hearing aids, a first signal processing unit 714A of the signal processing unit 714 is configured to determine a first processed signal 708 based on the second frequency-domain signal 706BA and the third frequency-domain signal 706CA. In one or more example hearing aids, the first signal processing unit 714A is configured to determine the first processed signal 708 by applying a multi-channel processing technique to the second frequency-domain signal 706BA and the third frequency-domain signal 706CA. In one or more example hearing aids, the first signal processing unit 714A is configured to determine the first processed signal 708 by applying a multi-channel processing technique to the second frequency-domain signal 706BA and the third frequency-domain signal 706CA.

Optionally, the signal processing unit 714 is configured to determine a first primary frequency-domain signal 706AAA based on the first frequency-domain signal 706AA (e.g., the first frequency range of the first frequency-domain signal 706AA). For example, the first primary frequency-domain signal 706AAA is associated with the first frequency range ΔF₁. In other words, the first primary frequency-domain signal 706AAA may indicate the first frequency-domain signal 706AA for the first frequency range ΔF₁. The first frequency range ΔF₁ may comprise a set of CF components, e.g., a set of frequencies which are common to both the set of frequencies of the second frequency-domain signal 706BA and the set of frequencies of the third frequency-domain signal 706CA. For example, the first signal processing unit 714A is configured to determine the first processed signal 708 based on the first primary frequency-domain signal 706AAA, the second frequency-domain signal 706BA, and the third frequency-domain signal 706CA. For example, the first signal processing unit 714A is configured to determine the first processed signal 708 by applying a multi-channel processing technique to the first primary frequency-domain signal 706AAA, the second frequency-domain signal 706BA and the third frequency-domain signal 706CA.

The multi-channel processing technique may comprise a beamforming technique. For example, the first signal processing unit 714A may be configured to combine the second frequency-domain signal 706BA with the third frequency-domain signal 706CA, in such a way that spatial filtering of sounds from the environment of the third hearing aid 700 is achieved. The first input signal 702AA (e.g., the wireless signal, e.g., the streamed music signal) may not be used for beamforming. Optionally, the first signal processing unit 714A may be configured to combine the second frequency-domain signal 706BA, the third frequency-domain signal 706CA, and the first primary frequency-domain signal 706AAA. The first input signal 702AA (e.g., the wireless signal, e.g., the streamed music signal) may be used for beamforming. For example, combination of the second frequency-domain signal 706BA, the third frequency-domain signal 706CA, and the first primary frequency-domain signal 706AAA may ensure audibility of both the ambient background around the user and the streamed music signal.

In one or more example hearing aids, the signal processing unit 714 is configured to determine a first secondary frequency-domain signal 706AAB based on the first frequency-domain signal 706AA. For example, the first secondary frequency-domain signal 706AAB is associated with the second frequency range ΔF₂. The first secondary frequency-domain signal 706AAB may indicate the first frequency-domain signal 706AA for the second frequency range ΔF₂, such as for the second part of the set of first frequency components. The second frequency range ΔF₂ may comprise a set of NCF components.

The second frequency-domain signal 706BA may indicate the second frequency-domain signal 706BA for the first frequency range ΔF₁, such as for the same set of frequency components as the first frequency-domain signal 706AA.

In one or more example hearing aids, the second signal processing unit 714 is configured to determine a second processed signal 710A based on the first secondary frequency-domain signal 706AAB and the first processed signal 708.

For example, the second signal processing unit 714B comprises a mixing unit 710 configured to determine the second processed signal 710A. The mixing unit 710 may be configured to combine the first processed signal 708 (e.g., a combination of the CF components of the second frequency-domain signal 706BA and the third frequency-domain signal 706CA) with the second processed signal 710A (e.g., the NCF components of the first frequency-domain signal 706AA). For example, the mixing unit 710 can be seen as a merging unit configured to combine (e.g., concatenate) the NCF components of the first frequency-domain signal 706AA and a combined version of the frequency components of the second frequency-domain signal 706BA and the frequency components of the third frequency domain signal 706CA into a joint vector. The second processed signal 710A may be seen as a joint vector. For example, the second processed signal 710A is a frequency-domain signal, e.g., a full band signal.

For example, the second signal processing unit 714B is configured to determine the third processed signal 712A based on the second processed signal 710A. For example, the second signal processing unit 714B is configured to determine the third processed signal 712A by applying a single-channel processing technique to the second processed signal 710A. For example, the second signal processing unit 714B comprises a single-channel processing unit 712 configured to apply the single-channel processing technique to the second processed signal 710A. The single-channel processing technique may comprise one or more of: a noise reduction technique, a hearing loss compensation technique, a VAD technique, an OVD technique, a feedback cancellation technique, and any other suitable single-channel processing technique. The third processed signal 712A may be a frequency-domain signal, e.g., a full band signal further processed for one or more of: noise reduction, hearing loss compensation, VAD, OVD, and feedback cancellation.

In one or more example hearing aids, the signal processing unit 714 comprises a synthesis filter 713 configured to determine the processed signal 714C based on the third processed signal 712C. For example, the synthesis filter 713 is configured to determine the processed signal 714C by converting the third processed signal 712A to a time-domain signal. The processed signal 714C may be a time-domain signal. For example, the synthesis filter 713 is configured to operate on the highest sampling rate among the first sampling rate f₁ and the second sampling rate f₂, such as on the first sampling rate f₁.

FIGS. 3A-3B may illustrate a hearing aid comprising a first microphone, a second microphone, and a wireless receiver, in which the first input signal received by the wireless receiver is sampled at a higher sampling rate (e.g., at the first sampling rate f₁) than the sampling rate of the second input signal provided by the first microphone and the sampling rate of the third input signal provided by the second microphone.

FIGS. 3A-3B may illustrate an example scenario where the user of the hearing aid is listening to a streamed audio signal, such as a music signal. Listening to music at a higher sampling rate may increase the quality of the music signal. It may be advantageous to use the first sampling rate f₁ at the channel receiving the streamed audio signal rather than sampling one of the input signals provided by the microphones 706BA, 706CA using the first sampling rate f₁, e.g., the higher sample rate among the first sampling rate f₁ and the second sampling rate f₂.

For example, embodiments of the present disclosure can be useful in audio streaming applications, such as in music streaming. It may be advantageous that a wirelessly received audio signal is sampled at a sampling rate greater than the sampling rate at which the microphone signals are sampled at.

It is an advantage of the present disclosure that, by having the first input signal 702AA (e.g., a streamed audio signal) sampled at a sampling rate greater than the sampling rate of the second input signal 702BA and the third input signal 702CA (e.g., microphone signals), a reduced computational complexity can be achieved when the hearing aid operates at higher sampling rates, in turn improving battery performance while delivering a music signal with satisfactory quality. Embodiments of the present disclosure can advantageously allow that the streamed audio signal and the microphone signals are available to the user of the hearing aid as the CF components of the microphone signals (e.g., sampled at the first sampling rate f₂) are combined in the first signal processing unit and the NCF of the audio streamed signal are combined with the combined version of the CF components of the microphone signals in the second signals processing unit.

Embodiments of the present disclosure may enable that the NCF channel can be changed adaptively. In other words, during music streaming, a wireless channel containing the NCF part of a wireless signal, but in absence of music, the NCF channel may switch to one of the microphone channels. In other words, the NCF channel may be used to transmit a digitized signal sampled at a sampling rate lower than the sampling rate of a streamed wireless signal (e.g., music signal), instead of transmitting the streamed wireless signal.

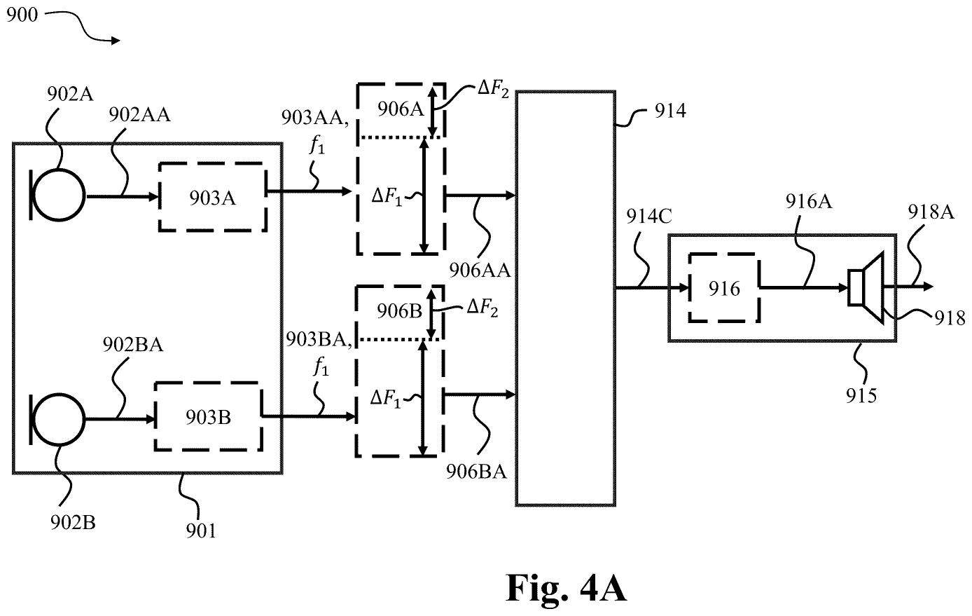

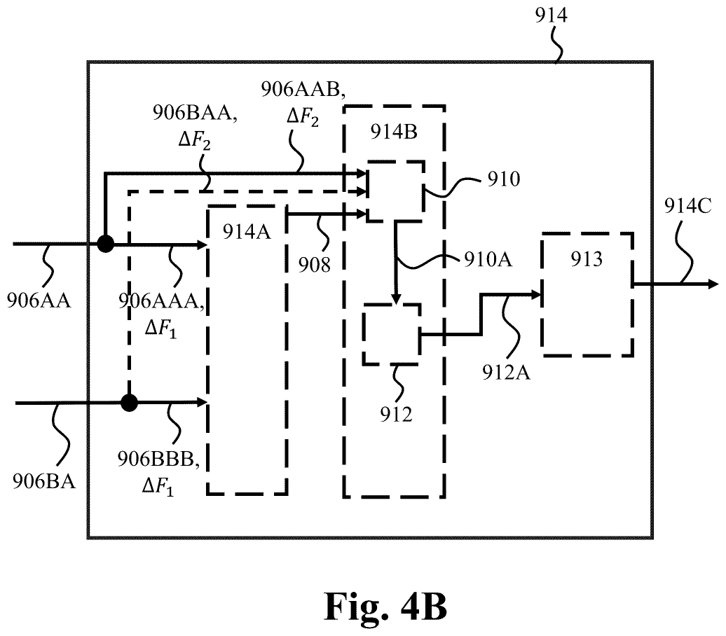

FIGS. 4A-4B schematically illustrates an example fourth hearing aid 900 according to the present disclosure. FIG. 4A shows the fourth hearing aid 900 comprising an input unit 901, a signal processing unit 914, and an output unit 915.

In the embodiment of FIG. 4A, the input unit 901 is configured to provide a first digitized signal 903AA and a second digitized signal 903BA, the first digitized signal 903AA and the second digitized signal 903BA being associated with the same sampling rate f₁. Optionally, the input unit 901 can be configured to provide at least two digitized signals, the at least two digitized signals being associated with the same sampling rate f₁. Such sampling rate f₁ is greater than a maximum sampling rate supported by a synthesis filter (e.g., synthesis filter 913 of FIG. 4B) of the fourth hearing aid 900.

For example, the sampling rate f₁ can be equal to 20 kHz, 21 kHz, 22 kHz, 23 kHz, 24 kHz, 25 kHz, 26 kHz, 27 kHz, 28 kHz, 29 kHz, 30 kHz, 31 kHz, 32 kHz, 33 kHz, 34 kHz, 35 kHz, 36 kHz, 37 kHz, 38 kHz, 39 kHz, 40 kHz, 41 kHz, 42 kHz, 44 kHz, or 44.1 kHz. For example, the sampling rate f₁ can be greater than 20 kHz, 24 kHz, 30 kHz, 32 kHz, or 44.1 kHz. For example, the sampling rate f₁ can range from 8 kHz to 48 kHz.

In one or more example hearing aids, the input unit 901 comprises a plurality of microphones and a plurality of AD conversion units. In the embodiment of FIG. 1A, the plurality of microphones comprises a first microphone 902A and a second microphone 902B. In the embodiment of FIG. 4A, the plurality of AD conversion units comprises a first AD conversion unit 903A and a second AD conversion unit 903B.

In one or more example hearing aids, the first microphone 902A is configured to provide a first input signal 902AA. For example, the first input signal 902AA comprises a microphone signal representative of a sound in an environment of the fourth hearing aid 900. In other words, the first input signal 902AA may be seen as a microphone signal.

In one or more example hearing aids, the second microphone 902B is configured to provide a second input signal 902BA. For example, the second input signal 902BA comprises a microphone signal representative of the sound in the environment of the fourth hearing aid 900. In other words, the second input signal 902BA may be seen as a microphone signal.

Optionally, the input unit 901 can comprise a wireless receiver (e.g., wireless receiver 702A of FIGS. 3A-3B) configured to receive the first input signal 902AA and/or the first input signal 902BA). The first input signal 902AA may be a wireless signal. The second input signal 902BA may be a wireless signal. The first input signal 902AA and the second input signal 302BA may be wireless signals.

In one or more example hearing aids, the first AD conversion unit 903A and the second AD conversion unit 903B are configured to digitize the first input signal 902AA and the second input signal 902BA using the same sampling rate f₁ for provision of the first digitized signal 903AA and the second digitized signal 903BA, respectively.

For example, the first AD conversion unit 903A is configured to digitize the first input signal 902AA using the sampling rate f₁ for provision of the first digitized signal 903AA. Put differently, the first AD conversion unit 903A may be configured to provide the first digitized signal 903AA by sampling the first input signal 902AA at the sampling rate f₁. In one or more examples, the second AD conversion unit 903B is configured to digitize the second input signal 902BA using the sampling rate f₁ for provision of the second digitized signal 903BA. Put differently, the second AD conversion unit 903B may be configured to provide the second digitized signal 903BA by sampling the second input signal 902BA at the sampling rate f₁. For example, the sampling rate f₁ of FIG. 4A is a sampling rate as high as the first sampling rate f₁ of FIGS. 1-3B.

Optionally, the fourth hearing aid 900 can comprise a single AD conversion unit (not shown in FIG. 4A) configured to digitize the first input signal 902AA and the second input signal 902BA using other sampling rate (e.g., the third sampling rate referred in FIGS. 1-3B) for provision of a first primary digitized signal and a second primary digitized signal. In other words, the single AD conversion unit may be configured to sample the first input signal 902AA and the second input signal 902BA at the other sampling rate. For example, the other sampling rate is different from the sampling rate f₁. For example, the input unit 901 is configured to apply a downsampling technique to the first primary digitized signal and the second primary digitized signal when the other sampling rate is (e.g., much) greater than the sampling rate f₁ for provision of the first digitized signal 903AA and the second digitized signal 903BA. For example, the input unit 901 is configured to apply an upsampling technique to the first primary digitized signal and the second primary digitized signal when the other sampling rate is (e.g., much) lower than the sampling rate f₁ for provision of the first digitized signal 903AA and the second digitized signal 903BA.

Optionally, the first AD conversion unit 903A and the second AD conversion unit 903B (e.g. a phone, a computer, etc.) are included in an auxiliary device. The fourth hearing aid 900 may be configured to receive, from the auxiliary device, the first digitized signal 903AA and the second digitized signal 903BA, both digitized signals being sampled at the sampling rate f₁. For example, the single AD conversion unit can be included in an auxiliary device.

For example, a wireless signal can be a digitally sampled signal associate with a sampling rate different from the sampling rate f₁. An AD conversion unit (e.g., the first AD conversion unit 903A, the second AD conversion unit 903B, and/or the single AD conversion unit) may be configured to re-sample the wireless signal (e.g., the first input signal 902AA and/or the second input signal 902BA) in such a way that a resulting digitized signal (e.g., the first digitized signal 903AA and/or the second digitized signal 903BA) is associated with the sampling rate f₁.

In one or more example hearing aids, the fourth hearing aid 900 comprises a plurality of analysis filter banks comprising a first analysis filter bank 906A and a second analysis filter bank 906B. Optionally, the input unit 901 can comprise the first analysis filter bank 906A and the second analysis filter bank 906B. For example, the first analysis filter bank 906A is configured to provide a first frequency-domain signal 906AA based on the first digitized signal 903AA. The first frequency-domain signal 906AA may be associated with a first frequency range ΔF₁ and a second frequency range ΔF₂. The first analysis filter bank 906A may be associated with a set of first frequency components. For example, a first part of such set of first frequency components can be seen as the first frequency range ΔF₁ of the first frequency-domain signal 906AA. For example, a second part of such set of first frequency components can be seen as the second frequency range ΔF₂ of the first frequency-domain signal 906AA.

In one or more example hearing aids, the second analysis filter bank 906B is configured to provide a second frequency-domain signal 906BA based on the second digitized signal 903BA. The second frequency-domain signal 906BA may be associated with the first frequency range ΔF₁ and the second frequency range ΔF₂. The second analysis filter bank 906B may be associated with a set of second frequency components. For example, a first part of such set of second frequency components can be seen as the first frequency range ΔF₁ of the second frequency-domain signal 906BA. For example, a second part of such set of second frequency components can be seen as the second frequency range ΔF₂ of the second frequency-domain signal 906BA. The first part of the set of first frequency components set may be the same as the first part of the set of second frequency components. The frequency bands of the first frequency-domain signal 906AA associated with the first frequency range ΔF₁ are the same as the frequency bands of the second frequency-domain signal 906BA associated with the first frequency range ΔF₁. The second part of the set of first frequency components set may be the same as the second part of the set of second frequency components. The frequency bands of the first frequency-domain signal 906AA associated with the second frequency range ΔF₂ are the same as the frequency bands of the second frequency-domain signal 906BA associated with the second frequency range ΔF₂. The first frequency-domain signal 906AA and the second frequency-domain signal 906BA is associated with the same frequency range (e.g., comprising the first frequency range and the second frequency range).

The signal processing unit 914 is configured determine a processed signal 914C based on the first digitized input signal 903AA and the second digitized input signal 903BA. For example, the signal processing unit 914 is configured determine a processed signal 914C based on the first frequency-domain signal 906AA and the second frequency-domain signal 906BA.

In one or more example hearing aids, the output unit 915 comprises a DA conversion unit 916 configured to convert the processed signal 914C (e.g., a digital signal) to an analogue output signal 916C, such as for being presented to the user wearing the fourth hearing aid 900 via the output unit 915 (e.g., output transducer 918, such as a loudspeaker).

In one or more example hearing aids, the output unit 915 is configured to output, based on the processed signal 914C, an audible signal 918A to the user wearing the fourth hearing aid 900. In the embodiment of FIG. 4A, the output unit 915 is configured to output the audible signal 918A based on the analogue output signal 916A. The analogue output signal 916A may be converted into an acoustic signal via the output transducer 918.

FIG. 4B shows the signal processing unit 914 of the fourth hearing aid 900. The signal processing unit 914 may comprise a first signal processing unit 914A and a second signal processing unit 914B.

In one or more example hearing aids, the signal processing unit 914 is configured to determine a first primary frequency-domain signal 906AAA based on the first frequency-domain signal 906AA. For example, the first primary frequency-domain signal 906AAA is associated with the first frequency range ΔF₁. In other words, the first primary frequency-domain signal 906AAA may indicate the first frequency-domain signal 906AA for the first frequency range ΔF₁.

In one or more example hearing aids, the signal processing unit 914 is configured to determine a second primary frequency-domain signal 906BBB based on the second frequency-domain signal 906BA. For example, the second primary frequency-domain signal 906BBB is associated with the first frequency range ΔF₁. In other words, the second primary frequency-domain signal 906BBB may indicate the second frequency-domain signal 906BA for the first frequency range ΔF₁.

In one or more example hearing aids, the first signal processing unit 914A is configured to determine a first processed signal 908 based on the first primary frequency-domain signal 906AAA and the second primary frequency-domain signal 906BBB. In one or more example hearing aids, the first signal processing unit 914 is configured to determine the first processed signal 908 by applying a multi-channel processing technique to the first primary frequency-domain signal 906AAA and the second primary frequency-domain signal 906BBB. The multi-channel processing technique may comprise a beamforming technique. In other words, the first signal processing unit 914A may be configured to combine the first primary frequency-domain signal 906AAA with the second primary frequency-domain signal 906BBB in such a way that spatial filtering of sounds from the environment of the fourth hearing aid 900 is achieved.

In one or more example hearing aids, the signal processing unit 914 is configured to determine a first secondary frequency-domain signal 906AAB based on the first frequency-domain signal 906AA. For example, the first secondary frequency-domain signal 906AAB is associated with the second frequency range ΔF₂. The first secondary frequency-domain signal 906AAB may indicate the first frequency-domain signal 906AA for the second frequency range ΔF₂, such as for the second part of the set of first frequency components. In one or more example hearing aids, the signal processing unit 914 is configured to determine a second secondary frequency-domain signal 906BAA based on the second frequency-domain signal 906BA. For example, the second secondary frequency-domain signal 906BAA is associated with the second frequency range ΔF₂. The second secondary frequency-domain signal 906BAA may indicate the second frequency-domain signal 906AB for the second frequency range ΔF₂, such as for the second part of the set of second frequency components.

In one or more example hearing aids, the second signal processing unit 914B is configured to determine a second processed signal 910A based on the first processed signal 908 and one or more of: the first secondary frequency-domain signal 906AAB and the second secondary frequency-domain signal 906BAA.

For example, the second processed signal 910A can be determined based on the first processed signal 908 and the first secondary frequency-domain signal 906AAB. For example, the second processed signal 910A can be determined based on the first processed signal 908 and the second secondary frequency-domain signal 906BAA. For example, the second processed signal 910A can be determined based on the first processed signal 908, the first secondary frequency-domain signal 906AAB and the second secondary frequency-domain signal 906BAA.

For example, the second signal processing unit 914B is configured to determine the second processed signal 910A by combining the first processed signal 908 with one or more of: the first secondary frequency-domain signal 906AAB and the second secondary frequency-domain signal 906BAA. For example, the second signal processing unit 914B is configured to determine the second processed signal 910A by summing (e.g., adding) the first secondary frequency-domain signal 906AAB and the second secondary frequency-domain signal 906BAA (e.g., when the second processed signal 910A can be determined based on the first processed signal 908, the first secondary frequency-domain signal 906AAB and the second secondary frequency-domain signal 906BAA) for provision of a combined second frequency range signal (e.g., not shown in FIG. 4B). For example, the second signal processing unit 914B is configured to determine the second processed signal 910A by applying a gain to each of the first secondary frequency-domain signal 906AAB and the second secondary frequency-domain signal 906BAA (e.g., when the second processed signal 910A can be determined based on the first processed signal 908, the first secondary frequency-domain signal 906AAB and the second secondary frequency-domain signal 906BAA) for provision of the combined second frequency range signal (e.g., not shown in FIG. 4B). For example, the combined second frequency range signal can result from a linear combination of the first secondary frequency-domain signal 906AAB and the second secondary frequency-domain signal 906BAA.

In one or more example hearing aids, the second signal processing unit 914B is configured to determine the second processed signal 910A based on the first processed signal 908 (e.g., a combined first frequency range signal) and the combined second frequency range signal. For example, the second signal processing unit 914B comprises a mixing unit 912 configured to determine the second processed signal 910A.

For example, the second signal processing unit 914B (e.g., the mixing unit 912) is configured to determine the second processed signal 910A based on the first processed signal 908 (e.g., a combined first frequency range signal) and the combined second frequency range signal (e.g., when the second processed signal 910A can be determined based on the first processed signal 908, the first secondary frequency-domain signal 906AAB and the second secondary frequency-domain signal 906BAA). Put differently, the second signal processing unit 914B (e.g., the mixing unit 912) may be configured to concatenate the first processed signal 908 with the combined second frequency range signal resulting in a joint vector, such as a vector representing the second processed signal 910A. For example, the second signal processing unit 914B (e.g., the mixing unit 912) may be configured to combine the first processed signal 908 with one or more of: the first secondary frequency-domain signal 906AAB and the second secondary frequency-domain signal 906BAA. For example, the second signal processing unit 914B (e.g., the mixing unit 912) may be configured to concatenate the first processed signal 908 with the first secondary frequency-domain signal 906AAB resulting in a joint vector, such as a vector representing the second processed signal 910A. For example, the second signal processing unit 914B (e.g., the mixing unit 912) may be configured to concatenate the first processed signal 908 with the second secondary frequency-domain signal 906AAB resulting in a joint vector, such as a vector representing the second processed signal 910A. For example, the second processed signal 910A is a frequency-domain signal, e.g., a full band signal. For example, it is an advantage of the present disclosure that, by applying simple computations to the combined second frequency range signal (e.g., additions and/or application of a gain), computational complexity and battery power (e.g., battery consumption) is saved.

In one or more example hearing aids, the second signal processing unit 914B is configured to determine a third processed signal 912A based on the second processed signal 910A. For example, the second signal processing unit 914B is configured to determine the third processed signal 912A by applying a single-channel processing technique to the second processed signal 910A. The single-channel processing technique may comprise one or more of: a noise reduction technique, a hearing loss compensation technique, a VAD technique, an OVD technique, a feedback cancellation technique, and any other suitable single-channel processing technique. The third processed signal 912A may be a frequency-domain signal, e.g., a full band signal further processed for one or more of: noise reduction, hearing loss compensation, VAD, OVD, and feedback cancellation.

In one or more example hearing aids, the signal processing unit 914 comprises a synthesis filter 913 configured to determine the processed signal 914C based on the third processed signal 912C. For example, the synthesis filter 913 is configured to determine the processed signal 914C by converting the third processed signal 912A to a time-domain signal. The processed signal 914C may be a time-domain signal. For example, the synthesis filter 913 is configured to operate on the highest sampling rate of the first sampling rate f₁ and the second sampling rate f₂. Optionally, the synthesis filter 913 is configured to operate on the lowest sampling rate of the first sampling rate f₁ and the second sampling rate f₂. For example, the synthesis filter may be configured to provide the processed signal as a time-domain signal sampled at the first sampling rate or at the second sampling rate.

For example, the second processed signal 914B can be configured to determine the third processed signal 912A by applying the single channel processing technique to the frequency range which is available in the synthesis filter 913. For example, the second processed signal 914B can be configured to determine the third processed signal 912A by applying the single channel processing technique to the second processed signal 910A (e.g., full band signal, e.g., with a frequency range of ΔF₁+ΔF₂). For example, the second processed signal 914B can be configured to determine the third processed signal 912A by applying the single channel processing technique to the portion of the second processed signal 910A associated with the first frequency range ΔF₁. For example, a single channel processing technique related to audibility (e.g., a hearing loss compensation technique and/or a feedback cancellation technique) may only be applied to the portion of the second processed signal 910A (e.g., to the first frequency range ΔF₁ of second processed signal 910A) intended to be presented to the user. For example, single channel detectors and/or single channel detection techniques (e.g., a noise reduction technique, a VAD technique, an OVD technique) can be applied to the second processed signal 910A, such as to the full band signal.

FIGS. 4A-4B may illustrate a hearing aid in which all input signals are sampled using a high sampling rate (e.g., using a first sampling rate that is greater than the second sampling rate of FIGS. 1A-3B), with each of the plurality of analysis filter bank having the same number of frequency bands (e.g., covering the same frequency range, such as the full frequency band the hearing aid is configured to operate on). However, not all frequency bands of the plurality of input signals may be necessarily processed by the signal processing unit. For example, the upper frequency channels to be processed by the second signal processing unit 914B can be based on a subset of input signals, e.g., on at least one of the plurality of input signals (e.g., a plurality of frequency-domain signals). In other words, only a subset of the frequency channels from the analysis filter banks 903A, 903B may be processed in the first signal processing unit 914A (e.g., for directional processing), such as the frequency components comprised in the first frequency range of the plurality of frequency-domain signals. The second signal processing unit 914B may process the frequency components comprised in the second frequency range of at least one of the plurality of frequency-domain signals. The second signal processing unit 914B may process the frequency components comprised in the second frequency range of at least two of the plurality of frequency-domain signals by summing such frequency components associated with the second frequency range of the at least two of the plurality of frequency-domain signals or by applying a gain to each of the at least two of the plurality of frequency-domain signals in the second frequency range. For example, it is an advantage of the present disclosure that, by applying simple computations (e.g., summations, application of gains) in the upper frequency channels (e.g., in frequency bands associated with the second frequency range), computational complexity and battery power (e.g., battery consumption) is saved. For example, it is an advantage of the present disclosure that, by processing upper frequency bands (e.g., frequency components associated with the second frequency range) of a subset of input signals of the plurality of input signals, computational complexity and battery power (e.g., battery consumption) is saved while ensuring that the fourth hearing aid 900 can operate with high sampling rates.

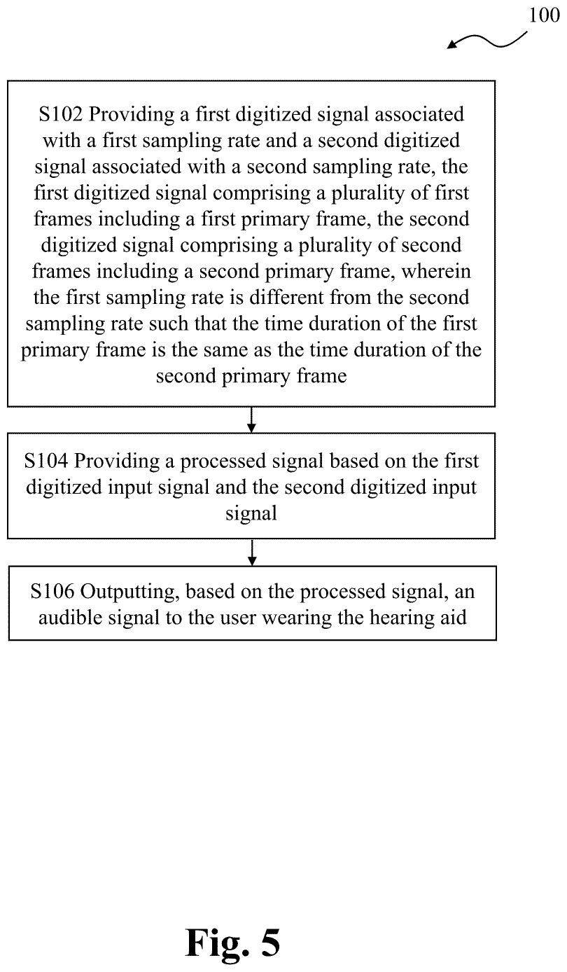

FIG. 5 illustrates a flow-chart of an example method 100 of operating a hearing aid according to the present disclosure.

The method 100 comprises providing S102 a first digitized signal associated with a first sampling rate and a second digitized signal associated with a second sampling rate. The first digitized signal comprises a plurality of first frames (e.g., including a first primary frame), each of the plurality of first frames comprising a number of first samples. The second digitized signal comprises a plurality of second frames (e.g., including a second primary frame), each of the plurality of first frames comprising a number of first samples. The method 100 comprises determining the first sampling rate as being greater than the second sampling rate such that the time duration of each of the plurality of first frames is the same as the time duration of each of the plurality of second frames, thereby causing (e.g., allowing and/or enabling) the number of first samples to be greater than the number of second samples. In other words, the first sampling rate is different from the second sampling rate such that the time duration of the first primary frame is the same as the time duration of the second primary frame.

The method comprises providing S104 a processed signal based on (e.g., a portion of) the first digitized input signal and the second digitized input signal. The method comprises outputting S106, based on the processed signal, an audible signal to the user wearing the hearing aid.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

Examples of methods and products (hearing aid) according to the disclosure are set out in the following items:
Item 1. A hearing aid comprising:
   an input unit configured to provide a first digitized signal associated with a first sampling rate and a second digitized signal associated with a second sampling rate, the first digitized signal comprising a plurality of first frames including a first primary frame, the second digitized signal comprising a plurality of second frames including a second primary frame, wherein the first sampling rate is different from the second sampling rate such that the time duration of the first primary frame is the same as the time duration of the second primary frame;
   a signal processing unit configured determine a processed signal based on the first digitized input signal and the second digitized input signal; and
   an output unit configured to output, based on the processed signal, an audible signal to the user wearing the hearing aid.
Item 2. The hearing aid according to item 1, wherein the hearing aid comprises a first analysis filter bank and a second analysis filter bank, wherein the first analysis filter bank is configured to provide a first frequency-domain signal based on the first digitized signal, the first frequency-domain signal being associated with a first frequency range and a second frequency range, wherein the second analysis filter bank is configured to provide a second frequency-domain signal based on the second digitized signal, the second frequency-domain signal being associated with the first frequency range.
Item 3. The hearing aid according to item 2, wherein the signal processing unit is configured to determine a first primary frequency-domain signal based on the first frequency-domain signal, the first primary frequency-domain signal being associated with the first frequency range.
Item 4. The hearing aid according to item 3, wherein the signal processing unit comprises a first signal processing unit configured to determine a first processed signal based on the first primary frequency-domain signal and the second frequency-domain signal.
Item 5. The hearing aid according to item 4, wherein to determine the first processed signal comprises to apply a multi-channel processing technique to the first primary frequency-domain signal and the second frequency-domain signal.
Item 6. The hearing aid according to item 5, wherein the multi-channel processing technique comprises a beamforming technique.
Item 7. The hearing aid according to any of items 2-6, wherein the signal processing unit is configured to determine a first secondary frequency-domain signal based on the first frequency domain signal, the first secondary frequency-domain signal being associated with the second frequency range.
Item 8. The hearing aid according to item 7, wherein the signal processing unit comprises a second signal processing unit configured to determine a second processed signal based on the first secondary frequency-domain signal and the first processed signal.
Item 9. The hearing aid according to item 8, wherein the second signal processing unit is configured to determine a third processed signal based on the second processed signal, wherein to determine the third processed signal comprises to apply a single-channel processing technique to the second processed signal.
Item 10. The hearing aid according to item 9, wherein the single-channel processing technique comprises one or more of: a noise reduction technique, a hearing loss compensation technique, a voice activity detection (VAD) technique, an own voice detection (OVD) technique, a feedback cancellation technique, and any other suitable single-channel processing technique.
Item 11. The hearing aid according to any of items 9-10, wherein the signal processing unit comprises a synthesis filter configured to determine the processed signal based on the third processed signal.
Item 12. The hearing aid according to any of items 1-11, wherein the input unit comprises a first analogue-to-digital (AD) conversion unit and a second AD conversion unit, the first AD conversion unit being configured to digitize a first input signal using the first sampling rate for provision of the first digitized signal, and the second AD conversion unit being configured to digitize a second input signal using the second sampling rate for provision of the second digitized signal.
Item 13. The hearing aid according to any of claims 1-12, wherein the input unit comprises an AD conversion unit configured to digitize the first input signal and the second input signal using a third sampling rate for provision of a first primary digitized signal and a second primary digitized signal, wherein the third sampling rate is different from the first sampling rate and the second sampling rate.
Item 14. The hearing aid according to claim 13, wherein the input unit is configured to apply a downsampling technique to the first primary digitized signal and the second primary digitized signal when the third sampling rate is greater than the first sampling rate and the second sampling rate for provision of the first digitized signal and the second digitized signal.
Item 15. The hearing aid according to any of items 13-14, wherein the input unit is configured to apply an upsampling technique to the first primary digitized signal and the second primary digitized signal when the third sampling rate is less than the first sampling rate and the second sampling rate for provision of the first digitized signal and the second digitized signal.
Item 16. The hearing aid according to any of items 12-15, wherein the first sampling rate is 30 kHz, and the second sampling rate is 20 kHz.
Item 17. The hearing aid according to any of items 12-15, wherein the first sampling rate is 32 kHz, and the second sampling rate is 20 kHz.
Item 18. The hearing aid according to any of items 12-15, wherein the first sampling rate is 44.1 kHz, and the second sampling rate is 32 kHz.
Item 19. The hearing aid according to any of items 12-18, wherein the first input signal comprises a wireless signal or a microphone signal representative of a sound in an environment of the hearing aid.
Item 20. The hearing aid according to any of items 12-19, wherein the second input signal comprises a wireless signal or a microphone signal representative of a sound in the environment of the hearing aid.
Item 21. A method of operating a hearing aid, the method comprising:
   providing a first digitized signal associated with a first sampling rate and a second digitized signal associated with a second sampling rate, the first digitized signal comprising a plurality of first frames including a first primary frame, the second digitized signal comprising a plurality of second frames including a second primary frame, wherein the first sampling rate is different from the second sampling rate such that the time duration of the first primary frame is the same as the time duration of the second primary frame;
   providing a processed signal based on the first digitized input signal and the second digitized input signal; and
   outputting, based on the processed signal, an audible signal to the user wearing the hearing aid.
Item 22. A hearing aid comprising:
   an input unit configured to provide a first digitized signal and a second digitized signal, the first digitized signal and a second digitized signal being associated with the same sampling rate, wherein such sampling rate is greater than a maximum sampling rate supported by a synthesis filter of the hearing aid;
   a signal processing unit configured determine a processed signal based on the first digitized input signal and the second digitized input signal; and
   an output unit configured to output, based on the processed signal, an audible signal to the user wearing the hearing aid.
Item 23. The hearing aid according to item 22, wherein the hearing aid comprises a first analysis filter bank and a second analysis filter bank, wherein the first analysis filter bank is configured to provide a first frequency-domain signal based on the first digitized signal, wherein the second analysis filter bank is configured to provide a second frequency-domain signal based on the second digitized signal, the first frequency-domain signal and the second frequency-domain signal being associated with a first frequency range and a second frequency range.
Item 24. The hearing aid according to item 23, wherein the signal processing unit is configured to determine a first primary frequency-domain signal based on the first frequency-domain signal and a second primary frequency-domain signal based on the second frequency-domain signal, the first primary frequency-domain signal and the second primary frequency-domain signal being associated with the first frequency range.
Item 25. The hearing aid according to item 24, wherein the signal processing unit comprises a first signal processing unit configured to determine a first processed signal based on the first primary frequency-domain signal and the second primary frequency-domain signal.
Item 26. The hearing aid according to item 25, wherein to determine the first processed signal comprises to apply a multi-channel processing technique to the first primary frequency-domain signal and the second primary frequency-domain signal.
Item 27. The hearing aid according to item 26, wherein the multi-channel processing technique comprises a beamforming technique.
Item 28. The hearing aid according to any of items 23-27, wherein the signal processing unit is configured to determine a first secondary frequency-domain signal based on the first frequency domain signal and a second secondary frequency-domain signal based on the second frequency domain signal, the first secondary frequency-domain signal and the second secondary frequency-domain signal being associated with the second frequency range.
Item 29. The hearing aid according to item 28, wherein the signal processing unit comprises a second signal processing unit configured to determine a second processed signal based on the first processed signal and one or more of: the first secondary frequency-domain signal and the second secondary frequency-domain signal.
Item 30. The hearing aid according to item 29, wherein the second signal processing unit is configured to determine a third processed signal based on the second processed signal, wherein to determine the third processed signal comprises to apply a single-channel processing technique to the second processed signal.
Item 31. The hearing aid according to item 30, wherein the single-channel processing technique comprises one or more of: a noise reduction technique, a hearing loss compensation technique, a voice activity detection (VAD) technique, an own voice detection (OVD) technique, a feedback cancellation technique, and any other suitable single-channel processing technique.
Item 32. The hearing aid according to item 30, wherein the signal processing unit comprises a synthesis filter configured to determine the processed signal based on the third processed signal.
Item 33. The hearing aid according to any of items 22-32, wherein the input unit comprises a first analogue-to-digital (AD) conversion unit and a second AD conversion unit, the first AD conversion unit and the second AD conversion unit being configured to digitize a first input signal and a second input signal using the same sampling rate for provision of the first digitized signal and the second digitized signal respectively.
Item 34. The hearing aid according to any of items 22-33, wherein the input unit comprises an AD conversion unit configured to digitize the first input signal and the second input signal using other sampling rate for provision of a first primary digitized signal and a second primary digitized signal, wherein the other sampling rate is different from the sampling rate.
Item 35. The hearing aid according to item 34, wherein the input unit is configured to apply a downsampling technique to the first primary digitized signal and the second primary digitized signal when the other sampling rate is greater than the sampling rate for provision of the first digitized signal and the second digitized signal.
Item 36. The hearing aid according to any of items 34-35, wherein the input unit is configured to apply an upsampling technique to the first primary digitized signal and the second primary digitized signal when the other sampling rate is less than the sampling rate for provision of the first digitized signal and the second digitized signal.
Item 37. The hearing aid according to any of items 33-36, wherein the sampling rate is greater than or equal to one or more of: 20 kHz, 24 kHz, 30 kHz, 32 kHz, 44.1 kHz.
Item 38. The hearing aid according to any of items 33-37, wherein the first input signal comprises a wireless signal or a microphone signal representative of a sound in an environment of the hearing aid.
Item 39. The hearing aid according to any of items 33-38, wherein the second input signal comprises a wireless signal or a microphone signal representative of a sound in the environment of the hearing aid.
Item 40. A method of operating a hearing aid comprising:
   an input unit configured to provide a first digitized signal and a second digitized signal, the first digitized signal and a second digitized signal being associated with the same sampling rate, wherein such sampling rate is greater than a maximum sampling rate supported by the hearing aid;
   a signal processing unit configured determine a processed signal based on the first digitized input signal and the second digitized input signal; and
   an output unit configured to output, based on the processed signal, an audible signal to the user wearing the hearing aid.

1. A hearing aid comprising:
an input unit configured to provide a first digitized signal associated with a first sampling rate and a second digitized signal associated with a second sampling rate, the first digitized signal comprising a plurality of first frames, each of the plurality of first frames comprising a number of first samples, the second digitized signal comprising a plurality of second frames, each of the plurality of second frames comprising a number of second samples,
wherein the hearing aid is configured to determine the first sampling rate as being greater than the second sampling rate such that the time duration of each of the plurality of first frames is the same as the time duration of each of the plurality of second frames, thereby causing the number of first samples to be greater than the number of second samples;
a first analysis filter bank configured to provide a first frequency-domain signal based on the first digitized signal, the first frequency-domain signal being associated with a first frequency range and a second frequency range;
a second analysis filter bank configured to provide a second frequency-domain signal based on the second digitized signal, the second frequency-domain signal being associated with the first frequency range;
wherein determination of the first and second sampling rates causes the first frequency range of the first frequency-domain signal to comprise the same frequency bands as the second frequency-domain signal; and
a signal processing unit configured to determine a first processed signal based on the first frequency range of the first frequency-domain signal and the second frequency-domain signal; and
an output unit configured to output, based on the first processed signal, an audible signal to the user wearing the hearing aid.

2. The hearing aid according to claim 1, wherein to determine the first processed signal comprises to apply a multi-channel processing technique to the first primary frequency-domain signal and the second frequency-domain signal, wherein the multi-channel processing technique comprises a beamforming technique.

3. The hearing aid according to claim 1, wherein the signal processing unit is configured to determine a second processed signal based on the first frequency range of the first frequency-domain signal and the first processed signal.

4. The hearing aid according to claim 3, wherein the signal processing unit is configured to determine a third processed signal based on the second processed signal, wherein to determine the third processed signal comprises to apply a single-channel processing technique to the second processed signal.

5. The hearing aid according to claim 4, wherein the single-channel processing technique comprises one or more of: a noise reduction technique, a hearing loss compensation technique, a voice activity detection (VAD) technique, an own voice detection (OVD) technique, a feedback cancellation technique, and any other suitable single-channel processing technique.

6. The hearing aid according to claim 4, wherein the signal processing unit comprises a synthesis filter configured to determine a processed signal based on the third processed signal, and wherein the output unit is configured to output, based on the processed signal, the audible signal to the user wearing the hearing aid.

7. The hearing aid according to claim 1, wherein the input unit is configured to:
digitize a first input signal using the first sampling rate for provision of the first digitized signal;
digitize a second input signal using the second sampling rate for provision of the second digitized signal; and
wherein each of the first input signal and second input signal comprises a wireless signal or a microphone signal representative of a sound in an environment of the hearing aid.

8. The hearing aid according to claim 1, wherein the hearing aid is configured to determine the first sampling rate as being greater than the second sampling rate in accordance with:
$$\frac{1}{{f}_{{s}_{1}}} {N}_{{l}_{1}} = \frac{1}{{f}_{{s}_{2}}} {N}_{{l}_{2}} ,$$
wherein Nₗ_{₁} denotes the number of first samples of the l-th frame of the plurality of first frames, fₛ_{₁} denotes the first sampling rate, Nₗ_{₂} denotes the number of second samples of the l-th frame of the plurality of second frames, and fₛ_{₂} denotes the second sampling rate.

9. The hearing aid according to claim 1, wherein the time duration of each of the plurality of first time frames and the plurality of second time frames is an integer multiple of the reciprocal of the greatest common divisor between the first sampling rate and the second sampling rate.

10. The hearing aid according to claim 1, wherein the first sampling rate is 30 kHz, and the second sampling rate is 20 kHz.

11. The hearing aid according to claim 1, wherein the first sampling rate is 32 kHz, and the second sampling rate is 20 kHz.

12. The hearing aid according to claim 1, wherein the first sampling rate is 44.1 kHz, and the second sampling rate is 32 kHz.

13. A method of operating a hearing aid, the method comprising:
providing a first digitized signal associated with a first sampling rate and a second digitized signal associated with a second sampling rate, the first digitized signal comprising a plurality of first frames, each of the plurality of first frames comprising a number of first samples, the second digitized signal comprising a plurality of second frames, each of the plurality of second frames comprising a number of second samples;
determining the first sampling rate as being greater than the second sampling rate such that the time duration of each of the plurality of first frames is the same as the time duration of each of the plurality of second frames, thereby causing the number of first samples to be greater than the number of second samples;
providing a first frequency-domain signal based on the first digitized signal, the first frequency-domain signal being associated with a first frequency range and a second frequency range;
providing a second frequency-domain signal based on the second digitized signal, the second frequency-domain signal being associated with the first frequency range, wherein determining the first and second sampling rates causes the first frequency range of the first frequency-domain signal to comprise the same frequency bands as the second frequency-domain signal; and
determining a first processed signal based on the first frequency range of the first frequency-domain signal and the second frequency-domain signal; and
outputting, based on the first processed signal, an audible signal to the user wearing the hearing aid.

14. A hearing aid comprising:
an input unit configured to provide a first digitized signal and a second digitized signal, the first digitized signal and a second digitized signal being associated with the same sampling rate, wherein such sampling rate is greater than a maximum sampling rate supported by a synthesis filter of the hearing aid;
a signal processing unit configured determine a processed signal based on the first digitized input signal and the second digitized input signal; and
an output unit configured to output, based on the processed signal, an audible signal to the user wearing the hearing aid.

15. The hearing aid according to claim 14, wherein the hearing aid comprises a first analysis filter bank and a second analysis filter bank, wherein the first analysis filter bank is configured to provide a first frequency-domain signal based on the first digitized signal, wherein the second analysis filter bank is configured to provide a second frequency-domain signal based on the second digitized signal, the first frequency-domain signal and the second frequency-domain signal being associated with a first frequency range and a second frequency range.

16. The hearing aid according to claim 15, wherein the signal processing unit is configured to determine a first processed signal based on the first frequency range of first frequency-domain signal and the first frequency range of second frequency-domain signal, wherein to determine the first processed signal comprises to apply a multi-channel processing technique to the first frequency range of first frequency-domain signal and the first frequency range of second frequency-domain signal, the multi-channel processing technique comprising a beamforming technique.

17. The hearing aid according to claim 16, wherein the signal processing unit is configured to determine a second processed signal based on the first processed signal and one or more of: the second frequency range of first frequency-domain signal and the second frequency range of second frequency-domain signal.

18. The hearing aid according to claim 17, wherein the second signal processing unit is configured to determine a third processed signal based on the second processed signal, wherein to determine the third processed signal comprises to apply a single-channel processing technique to the second processed signal, wherein the single-channel processing technique comprises one or more of: a noise reduction technique, a hearing loss compensation technique, a voice activity detection (VAD) technique, an own voice detection (OVD) technique, a feedback cancellation technique, and any other suitable single-channel processing technique.

19. The hearing aid according to claim 18, wherein the signal processing unit comprises a synthesis filter configured to determine the processed signal based on the third processed signal.

20. The hearing aid according to claim 1, wherein the sampling rate is greater than or equal to one or more of: 20 kHz, 24 kHz, 30 kHz, 32 kHz, 44.1 kHz.
